(19) United States
(12) Patent Application Publication
(10) Pub. No.: US 2026/0178493 A1
(43) Pub. Date: Jun. 25, 2026

(54) HOST MEMORY BUFFER USAGE IN IN-MEMORY DATA PROCESSING IN A MEMORY SYSTEM

(71) Applicant: SK Hynix NAND Product Solutions Corp. (dba Solidigm), Rancho Cordova, CA (US)

(72) Inventor: Samuel BRADSHAW, Sacramento, CA (US)

(21) Appl. No.: 19/387,590

(22) Filed: Nov. 12, 2025

Related U.S. Application Data
(63) Continuation-in-part of application No. 19/000,068, filed on Dec. 23, 2024.

(51) Int. Cl. G06F 12/0802

(52) U.S. Cl. CPC G06F 12/0802; G06F 2212/60

(57) ABSTRACT

This application is directed to managing memory resources for data caching in a memory device. A memory device has a plurality of processor cores, a volatile memory, and a non-volatile memory, and the processor cores are configured to provide a memory controller and a data processor. The memory device allocates a subset of volatile memory to the data processor, and determines that a target page is not stored in the subset of volatile memory. The memory device obtains the target page from a host memory buffer, and stores the target page in the subset of volatile memory allocated to the data processor. The data processor is configured to implement a computer operation based on the target page. In some embodiments, the memory device sends a request to a host via a Peripheral Component Interconnect Express (PCIe) bus, and receives the target page from the host via the PCIe bus.

### RELATED APPLICATIONS

This application is a continuation-in-part of, and claims benefits to, U.S. patent application Ser. No. 19/000,068, filed Dec. 23, 2024, titled “Volatile Memory Resource Sharing in a Memory System,” which is incorporated by reference in its entirety.

This application is also related to the following patent applications, each of which is incorporated by reference in its entirety:
U.S. patent application Ser. No. ______ (Attorney Docket No. 1332251-01-5094-US), filed titled “Multi-Tenant Volatile Memory Sharing in a Memory System”;
U.S. patent application Ser. No. ______ (Attorney Docket No. 1332251-01-5095-US), filed titled “Dynamic Volatile Memory Usage for In-Memory Data Processing”; and
U.S. patent application Ser. No. ______ (Attorney Docket No. 1332251-01-5097-US), filed titled “Dynamic Volatile Memory Usage for Input and Output Buffering in a Memory Device.”

### TECHNICAL FIELD

This application relates generally to data memory device including, but not limited to, methods, systems, and devices for managing volatile memory resources to implement memory operations and in-memory data processing operations in a memory system.

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency. The secondary memory have been developed to integrate local in-memory data processing capabilities; however, these capabilities are often limited by the constrained processing and buffering resources available on the second memory, as well as the prioritization of memory management operations. The overall effectiveness of in-memory data processing may heavily rely on allocation of resources within the secondary memory.

### SUMMARY

Various embodiments of this application are directed to methods, memory systems, and memory devices for managing local volatile memory resources (e.g., random-access memory space) to implement memory operations and in-memory data processing operations. In some embodiments, a controller of a memory device (e.g., an SSD) is configured to manage data storage, data retrieval, and interfacing with a host. A memory device (also called a storage device) includes a plurality of processing cores, and is transformed to a computational storage device (CSD) by providing both a memory controller and a data processor using the plurality of processing cores. The data processor is configured to process internal computational storage functions (e.g., data processing operations) locally on the memory device, and the memory controller of the memory device is configured to perform generic memory functions including memory access functions (e.g., input/output (I/O) access operations) and internal memory management functions. In some embodiments, an address space may be statically allocated to either of the memory controller and the data processor at a boot time, and onboard random-access memory space of the CSD is dynamically shared by the generic memory functions of the memory controller and the data processing operations of the data processor. More specifically, in some embodiments, dynamic random-access memory (DRAM), static random-access memory (SRAM), or both are shared between a host-interfacing nonvolatile memory express (NVMe) firmware and an in-memory Linux compute environment in a memory device (e.g., an SSD), and the address space is statically allocated to each side at the boot time.

In one aspect, a method is implemented by a memory device to manage memory resources. The memory device has a plurality of processor cores, a volatile memory, and a non-volatile memory. The method includes allocating a first subset of processor cores to perform a plurality of memory access and management functions of a memory controller, allocating a second subset of processor cores to perform a plurality of in-memory data processing functions of as a data processor, partitioning the volatile memory to (1) a first memory portion for storing address mapping data temporarily for the memory controller and (2) a second memory portion for storing payload data temporarily for the data processor. The method further includes receiving, from the data processor, a caching request for storing target data temporarily. The method further includes, in response to the caching request and in accordance with a determination that the second memory portion associated with the data processor has insufficient memory space to store the target data, storing the target data in the first memory portion via the memory controller.

In some embodiments, the method further includes, in response to the caching request and in accordance with a determination that the second memory portion has insufficient memory space to store the target data, updating a mapping table associating a virtual address of the target data with a physical address in the first memory portion of the volatile memory.

In some embodiments, the plurality of processor cores are grouped into a plurality of clusters. The first subset of processor cores of the memory controller correspond to a first set of one or more clusters, and the second subset of processor cores of the data processor correspond to a second set of one or more clusters, and the memory controller and the data processor share a cluster-level L3 cache.

In some embodiments, the memory device is coupled to a host device. The method further includes, by the memory controller, receiving a host write request including first data and a logical address of the first data and determining that the first memory portion has insufficient memory space to store a first mapping entry translating the logical address of the first data to a physical address of the first data. The method further includes, in response to the host write request and in accordance with a determination that the first memory portion has insufficient memory space to store the first mapping entry, determining a physical address in the non-volatile memory for storing the first data, storing the first mapping entry in one of the second memory portion and the non-volatile memory, and storing the first data in the non-volatile memory based on the physical address of the first data.

In another aspect, a method is implemented by a memory device to manage memory resources. The memory device is coupled to a host device, and has a plurality of processor cores, a volatile memory, and a non-volatile memory. The method includes allocating a first subset of processor cores to perform a plurality of memory access and management functions of a memory controller, allocating a second subset of processor cores to perform a plurality of in-memory data processing functions of as a data processor, partitioning the volatile memory to (1) a first memory portion for storing address mapping data temporarily for the memory controller and (2) a second memory portion for storing payload data temporarily for the data processor. The method further includes, by the memory controller, receiving a host write request including first data and a logical address of the first data and determining that the first memory portion has insufficient memory space to store a first mapping entry translating the logical address of the first data to a physical address of the first data. The method further includes in response to the host write request, in accordance with a determination that the first memory portion has insufficient memory space to store the first mapping entry: determining a physical address in the non-volatile memory for storing the first data, storing the first mapping entry in one of the second memory portion and the non-volatile memory, and storing the first data in the non-volatile memory based on the physical address of the first data.

In yet another aspect, a method is implemented for managing memory resources, e.g., to facilitate in-memory data processing. The method is implemented at a memory device having a plurality of processor cores, a volatile memory, and a non-volatile memory, and the plurality of processor cores are configured to provide a memory controller and a data processor. The method includes allocating a subset of volatile memory to the data processor, determining that a target page is not stored in the subset of volatile memory, obtaining the target page from a host memory buffer (HMB), and storing the target page in the subset of volatile memory allocated to the data processor. The data processor is configured to implement a computer operation based on the target page.

In some embodiments, obtaining the target page from the HMB further includes sending a data request for the target page from the data processor to the memory controller. Obtaining the target page from the HMB further includes, at the memory controller, in response to the data request, fetching the target page from the HMB and providing the target page to the data processor.

In some embodiments, obtaining the target page from the HMB further includes, in accordance with a Non-Volatile Memory express (NVMe) storage access and transport protocol, sending a first request to a host coupled to the memory device via a Peripheral Component Interconnect Express (PCIe) bus and receiving the target page from the host via the PCIe bus.

In yet another aspect, a method is implemented for managing memory resources, e.g., to facilitate in-memory data processing. The method is implemented at a memory device having a memory controller, a data processor, a volatile memory that further includes a first memory portion, and a non-volatile memory. The method includes storing a first paging structure in the first memory portion, and the first paging structure maps logical addresses of a plurality of first pages to physical addresses in one or more of the first memory portion, a host memory buffer (HMB), and the non-volatile memory. The method further includes executing a hypervisor based on the first paging structure, which further includes receiving a data request for a target page from the data processor; in response to the data request, searching the first paging structure stored in the first memory portion to identify a target location of the target page; based on the target location, fetching the target page from one of the first memory portion, the HMB, and the non-volatile memory; and providing the target page to the data processor.

In some embodiments, the memory device is coupled to a host device including a dynamic random-access memory (DRAM), and the DRAM is configured to provide the HMB using passthrough HMB memory semantics.

In some embodiments, the method further includes configuring, by the hypervisor, the first memory portion, the HMB, and the non-volatile memory to a plurality of paravirtualized memory devices.

In yet another aspect, a method is implemented for managing memory resources, e.g., to facilitate in-memory data processing. The method is implemented at a memory device having a memory controller, a data processor, a volatile memory, and a non-volatile memory. The volatile memory includes a first memory portion allocated to the memory controller and a second memory portion allocated to the data processor. The method includes caching, in the second memory portion, a plurality of pages to be used by the data processor. The method further includes monitoring a paging activity level at the second memory portion, and the paging activity level corresponds to at least a paging rate for fetching pages from one or more memory resources distinct from the second memory portion. The method further includes in accordance with a determination that the paging activity level satisfies a condition, adjusting a current size of the second memory portion allocated to the data processor.

In some embodiments, at a booting stage of the memory device, each of the first memory portion and the second memory portion has a respective predefined memory size. In some embodiments, the method further includes releasing a subset of the second memory portion by the data processor. Adjusting the current size of the second memory portion further includes, in accordance with a determination that the subset of the second memory portion is released, increasing the current size of the second memory portion allocated to the data processor by at least partially recovering the subset of the second memory portion. In some embodiments, the method further includes in accordance with the condition: when the paging activity level is greater than a first paging threshold, increasing the current size of the second memory portion by a first predefined portion.

In some embodiments, the paging rate is measured by a number of pages fetched from the one or more memory resources during a predefined duration of time. In some embodiments, the paging rate is measured by a number of pages victimized from the second memory portion during a predefined duration of time. In some embodiments, the paging activity level is based on a variation of the paging rate during a predefined duration of time. In some embodiments, the paging activity level further corresponds to a page access queue including a plurality of data requests to be fulfilled via the second memory portion.

In yet another aspect, a method is implemented for managing memory resources, e.g., to facilitate in-memory data processing. The method is implemented at a memory device having a memory controller, a data processor, a volatile memory, and a non-volatile memory. The volatile memory includes a first memory portion and a second memory portion distinct from the first memory portion. The method includes storing, in the second memory portion, a plurality of pages to be used by the data processor, allocating a subset of the second memory portion to act as an input/output (I/O) buffer for the memory controller, and storing a data block associated with the non-volatile memory temporarily in the I/O buffer.

In some embodiments, the method further includes, before storing the data block in the I/O buffer, receiving the data block with a logical address from one of the data processor and a host coupled to the memory device. The method further includes storing the data block in the non-volatile memory based on a physical address corresponding to the logical address. In some embodiments, the I/O buffer includes a read buffer. The method further includes, before storing the data block in the I/O buffer, receiving a read request including a logical address of the data block and extracting the data block from the non-volatile memory based on a physical address corresponding to the logical address. In some embodiments, the method further includes, after storing the data block in the I/O buffer, receiving, from a host or the data processor, an access request including a logical address of the data block, extracting the data block from the I/O buffer, and providing the data block extracted from the I/O buffer to the host or the data processor.

In another aspect, some implementations include a memory system or a memory device (e.g., SSDs) that includes a memory controller, a data processor distinct from the memory controller, a non-volatile memory coupled to the memory controller, and memory having instructions stored thereon for performing any of the above methods of managing memory resources (e.g., volatile memory space, HMB).

In yet another aspect, some implementations include a non-transitory computer readable storage medium storing one or more programs. The one or more programs include instructions, which when executed by a memory system (e.g., SSDs) or a memory device (e.g., an SSD) cause the memory system or the memory device to implement any of the above methods to manage memory resources (e.g., volatile memory, HMB).

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device, in accordance with some embodiments.

FIG. 3 is a block diagram of an example electronic system that includes a memory system having an internal processing capability, in accordance with some embodiments.

FIG. 4 is a block diagram of an example computer system including a memory system that operates in compliance with a storage access and transport protocol, in accordance with some embodiments.

FIGS. 5A-5C are block diagrams of an example electronic system that uses a block namespace for storing and retrieving data based on memory pages, in accordance with some embodiments.

FIG. 6 is a block diagram of an example electronic system that shares volatile memory space to facilitate in-memory data processing in a memory device, in accordance with some embodiments.

FIG. 7 is a block diagram of an example electronic system that shares volatile memory space to facilitate storage functions of a memory device, in accordance with some embodiments.

FIG. 8 is a block diagram of an example electronic system that stores one or more page tables in a non-volatile memory in a memory device, in accordance with some embodiments.

FIG. 9 is a flow diagram of an example method for managing volatile memory space in a memory device, in accordance with some embodiments.

FIG. 10 is a block diagram of another example electronic system that shares volatile memory space (e.g., an HMB of a host device) to facilitate in-memory data processing in a memory device, in accordance with some embodiments.

FIGS. 11A and 11B are block diagrams of an example electronic system that supplements a subset of volatile memory allocated to a data processor with an HMB of a host device, in accordance with some embodiments.

FIGS. 12A and 12B are block diagrams of another example electronic system that supplements a subset of volatile memory allocated to a data processor with a firmware memory buffer allocated to a memory controller, in accordance with some embodiments.

FIG. 13 is a flow diagram of an example method for managing volatile memory space in a memory device, in accordance with some embodiments.

FIG. 14 is a block diagram of an example electronic system that applies a hypervisor to manage memory resources and facilitate in-memory data processing in a memory device, in accordance with some embodiments.

FIGS. 15A and 15B are block diagrams of an example electronic system that applies a hypervisor to provide supplemental memory resources to a data processor, in accordance with some embodiments.

FIGS. 16A and 16B are block diagrams of an example electronic system that applies a hypervisor to fetch, for a data processor, data stored in a non-volatile memory by way of an HMB, in accordance with some embodiments.

FIG. 17 is a flow diagram of an example method for managing volatile memory space in a memory device, in accordance with some embodiments.

FIG. 18A is a block diagram of an example electronic system that dynamically applies volatile memory in a memory device, in accordance with some embodiments, and FIG. 18B illustrates an example process of releasing and reclaiming part of volatile memory by a data processor, in accordance with some embodiments.

FIGS. 19A and 19B are block diagrams of an example electronic system that dynamically manages memory space of volatile memory in a memory device, in accordance with some embodiments.

FIG. 20 is a block diagrams of an example electronic system that dynamically manages memory space of volatile memory in a memory device, in accordance with some embodiments.

FIG. 21 is a flow diagram of an example method for managing volatile memory space in a memory device, in accordance with some embodiments.

FIG. 22 is a block diagram of an example electronic system that reserves an input/output buffer for a memory controller, in accordance with some embodiments.

FIG. 23 is a flow diagram of an example method for dynamically managing volatile memory of a memory device to provide an I/O buffer, in accordance with some embodiments.

FIG. 24 is a flow diagram of an example method for managing volatile memory space in a memory device, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

A computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency. In some embodiments, a memory device (also called a storage device) includes a plurality of processing cores, and is transformed to a CSD by configuring two subsets of processing cores to a memory controller and a data processor, respectively. The data processor is configured to process internal computational storage operations (e.g., data processing operations) locally on the memory device, while the memory controller of the memory device specializes in performing generic storage functions including memory access functions (e.g., input/output (I/O) access operations) and internal memory management functions. In accordance with some embodiments of this application is at least a realization that the CSDs applied in many edge applications (e.g., mobile phones) often operate with buffers (e.g., DRAM and SRAM) that have a limited size and a static partition scheme.

Further, in accordance with some embodiments of this application is at least a realization that there is a need to share buffer space between a memory controller and a data processor of a memory device using storage semantics. Some implementations of this application are directed to sharing volatile memory (e.g., DRAM and SRAM) between memory storage and compute functions dynamically, e.g., using established NVMe protocol semantics to share memory. The volatile memory is partitioned to a first memory portion for storing address mapping data temporarily for the memory controller and a second memory portion for storing payload data temporarily for the data processor. The data processor issues a caching request for storing target data temporarily. In response to the caching request and in accordance with a determination that the second memory portion associated with the data processor has insufficient memory space to store the target data, the data processor stores the target data in the first memory portion via the memory controller.

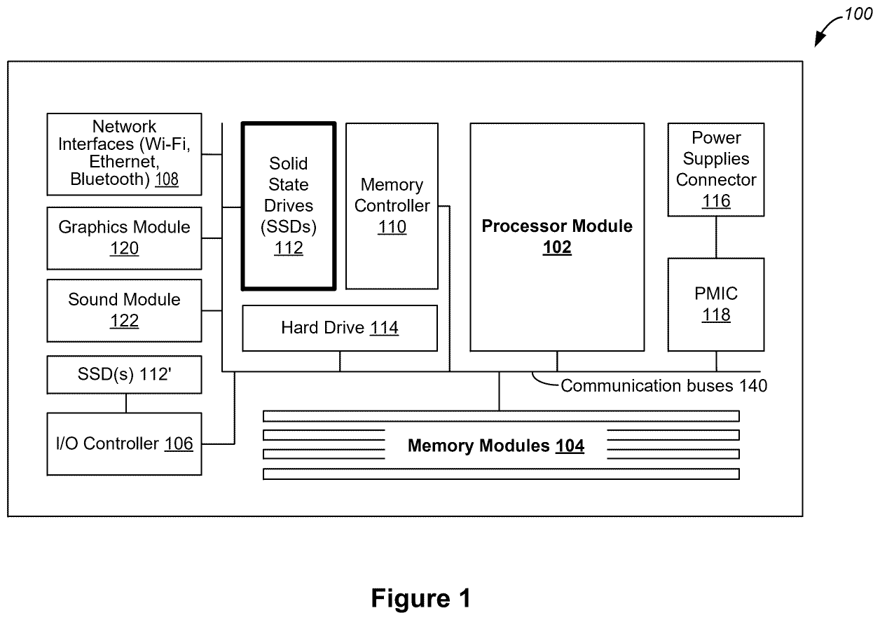

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data memory device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

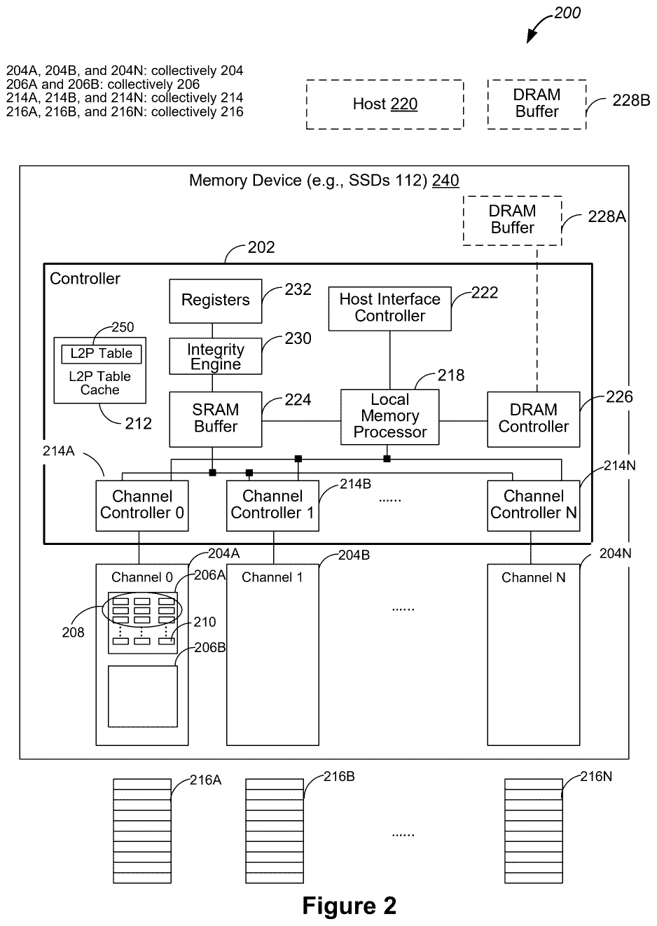

FIG. 2 is a block diagram of a memory system 200 of an example electronic device, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system (OS) and execute applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each memory block has a size corresponding to a plurality of pages distinct from 16 KB and 64 KB. In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

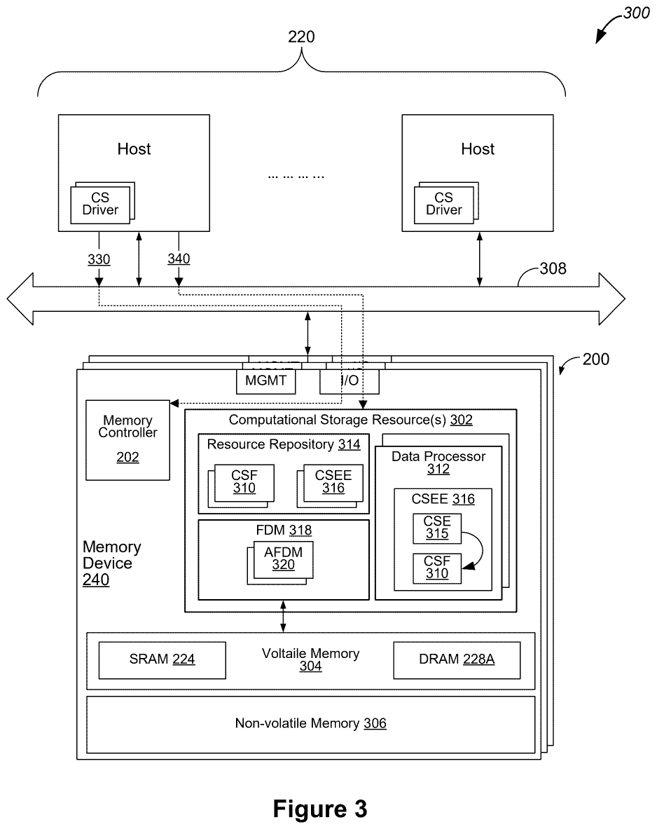

In some embodiments, a memory device 240 (also called a storage device) includes a plurality of processing cores and is transformed to a CSD by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of an example electronic system 300 that includes a memory system 200 having an internal processing capability, in accordance with some embodiments. The memory system 200 is also called a CSD, and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, an SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 220 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 220 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

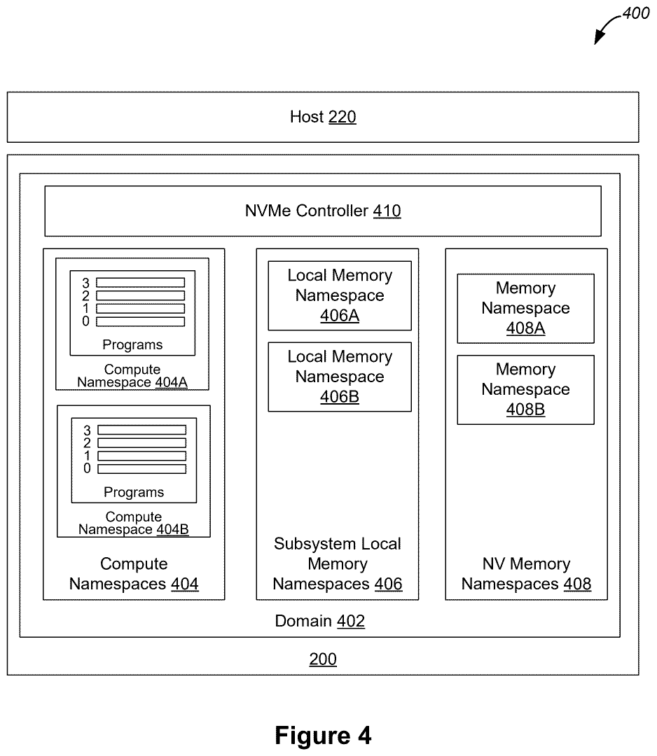

FIG. 4 is a block diagram of an example computer system 400 including a memory system 200 that operates in compliance with a storage access and transport protocol (e.g., nonvolatile memory express (NVMe)), in accordance with some embodiments. The memory system 200 includes one or more memory devices 240 each of which corresponds to a domain 402 according to the storage access and transport protocol. Each domain 402 corresponding to a respective memory device 240 includes a one or more compute namespace 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a cache 212, an SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes an NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe memory device using the NVMe protocol. The host device 220 is configured to read and write data and implement data processing operations on the memory device 240 using NVMe commands.

In some embodiments, the host device 220 uses an operating system (e.g., a Linux operating system), and the CSRs 302 (FIG. 3) of the memory device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the memory device 240.

### Volatile Memory Resource Sharing

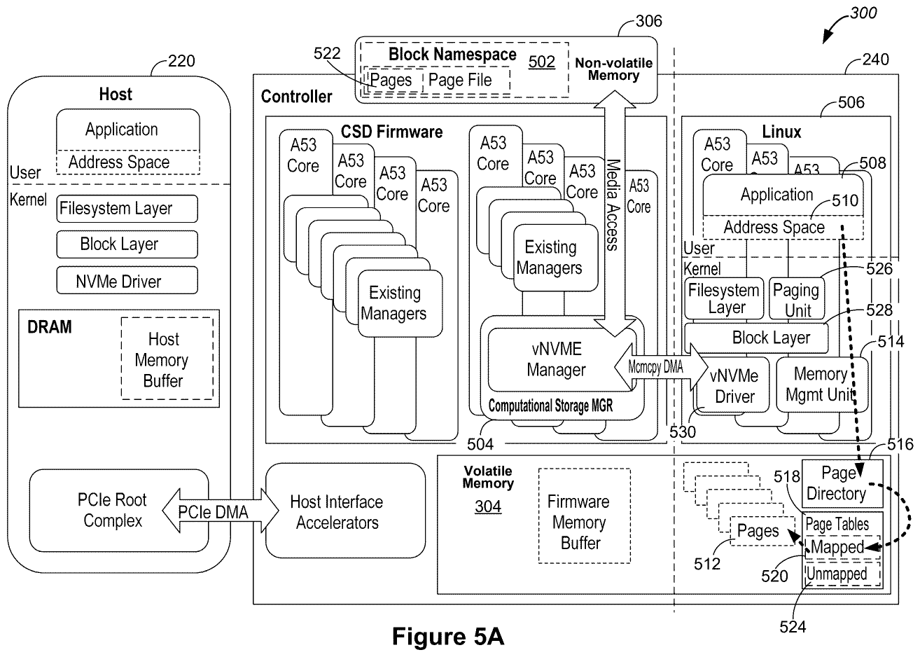

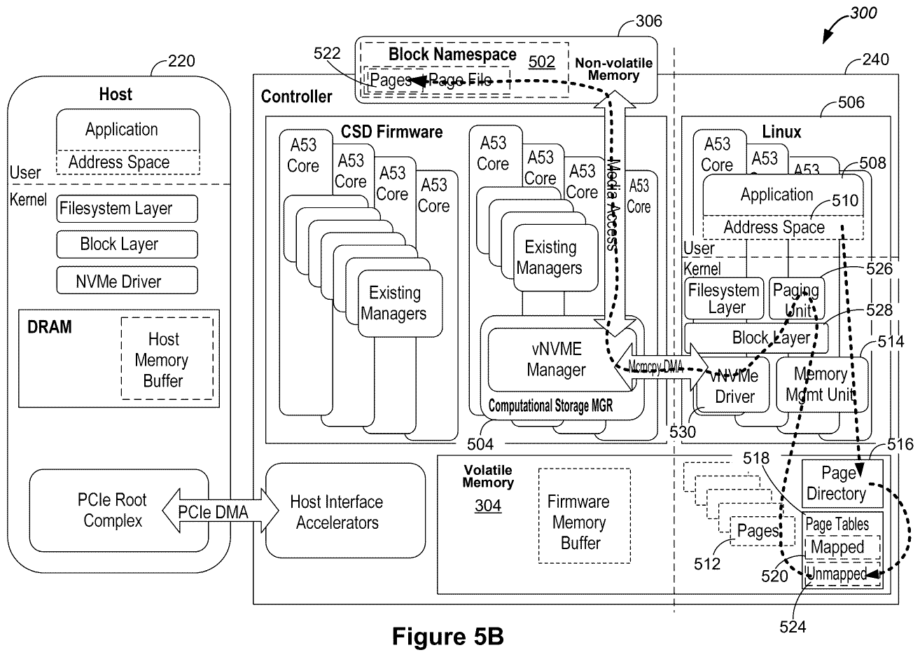

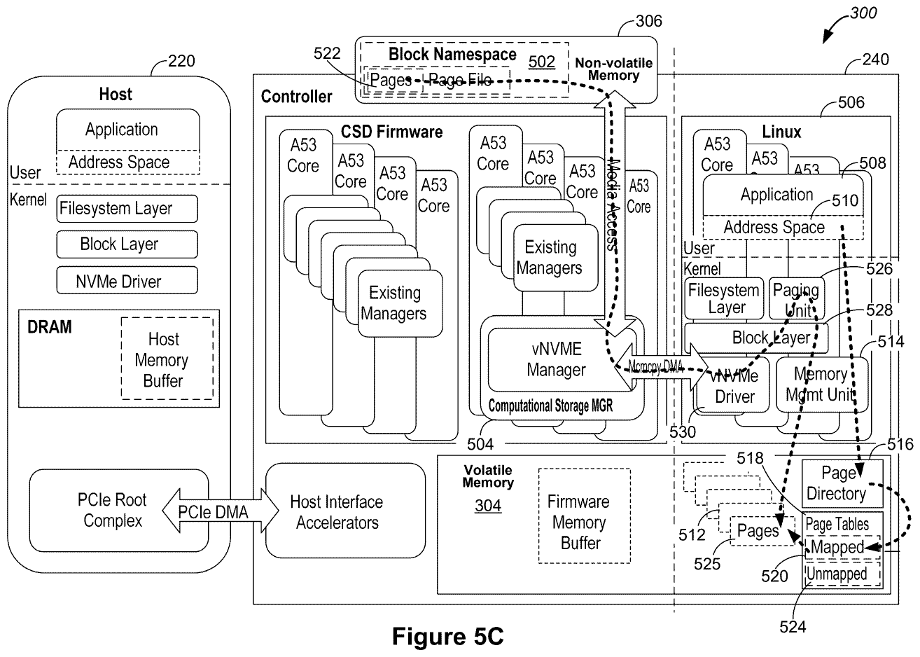

FIGS. 5A-5C are block diagrams of an example electronic system 300 that uses a block namespace 502 for storing and retrieving data (e.g., a file) based on memory pages 210, in accordance with some embodiments. The electronic system 300 includes a memory device 240 (e.g., an SSD) coupled to a host 220. The memory device 240 further includes a storage manager 504 and a Linux compute system 506. Some implementations of this application are directed to a shared memory architecture in which volatile memory 304 (e.g., DRAM 228A, SRAM 224) is shared between memory storage functions and compute functions of the memory device 240 dynamically, e.g., using established NVMe protocol semantics. The block namespace 502 may be isolated and used for paging a file for the Linux compute system 506, thereby providing an accelerated pathway due to the shared memory architecture. For example, data may be moved into and out of a shared L3 cache using memcpy, which is a standard C library function used to copy a block of memory from one location to another. In some embodiments, the memory device 240 operates in a single level cell (SLC) mode, when the shared memory architecture is applied.

In some embodiments, the Linux compute system 506 executes an application 508 having an address space 510 on an application level. The address space 510 includes a plurality of address space mappings to associate virtual addresses of the application 508 to physical addresses of pages 512 stored in the volatile memory 304 (e.g., the DRAM buffer 228A). A memory management unit (MMU) 514 is applied in an operating system kernel to configure the address space mappings of the address space 510 associated with the page 512 stored in the DRAM buffer 228A. In some embodiments, referring to FIG. 5A, the MMU 514 identifies a physical page 512 stored in the volatile memory 304 (e.g., the DRAM buffer 228A) in response to a request for an application page of the application 508 corresponding to a logical address. More specifically, the MMU 514 checks a page directory 516 to identify a page table 518 to identify the physical page 512 among a mapped portion 520 storing physical addresses of locally mapped pages (e.g., including a physical address of the page 512 within the DRAM buffer 228A).

In some embodiments, page table entries are mapped, indicating there is a page 512 backing every application page of the application 508. Conversely, in some embodiments, a translation lookaside buffer (TLB) miss happens when no physical page 512 stored in the DRAM buffer 228A is found for a logical address of the application 508. TLB miss causes a page table walk to identify a page 522 stored in the non-volatile memory 306 based on logical-to-physical (L2P) mapping. Referring to FIG. 5B, in some embodiments, the application 508 issues a request for a page 522, causing a page fault. A TLB miss happens. Information of the page 522 is stored in an unmapped portion 524 of the page tables 518. Transaction is routed through a kernel paging subsystem to extract the information of the page 522 from the unmapped portion 524 and identify the page 522 in a page file in the block namespace 502 on the non-volatile memory 306 based on the extracted information of the page 522. In some embodiments, the page directory 516 and the page table 518 are stored in a TLB. The TLB may be stored an SRAM buffer 224 or the DRAM buffer 228A.

Referring to FIG. 5C, in some embodiments, the page 522 is copied from the non-volatile memory 306 into a victim cache location (e.g., as a page 525) in the DRAM buffer 228A and mapped into the address space 510 associated with the application 508. A page fault handler returns, e.g., to store information of the page 525 (e.g., a physical address of the victim cache location) in the mapped portion 524 in the page tables 518. The application 508 can freely access the pages (e.g., page 512 or 525) identified in the mapped portion 524. In some embodiments, the kernel paging subsystem includes one or more of the MMU 514, a paging unit 526, a block layer 528, and a driver 530. The kernel paging subsystem is implemented by a data processor 312 of the memory device 240 and collaborates with the storage manager 504 implemented by a memory controller 202.

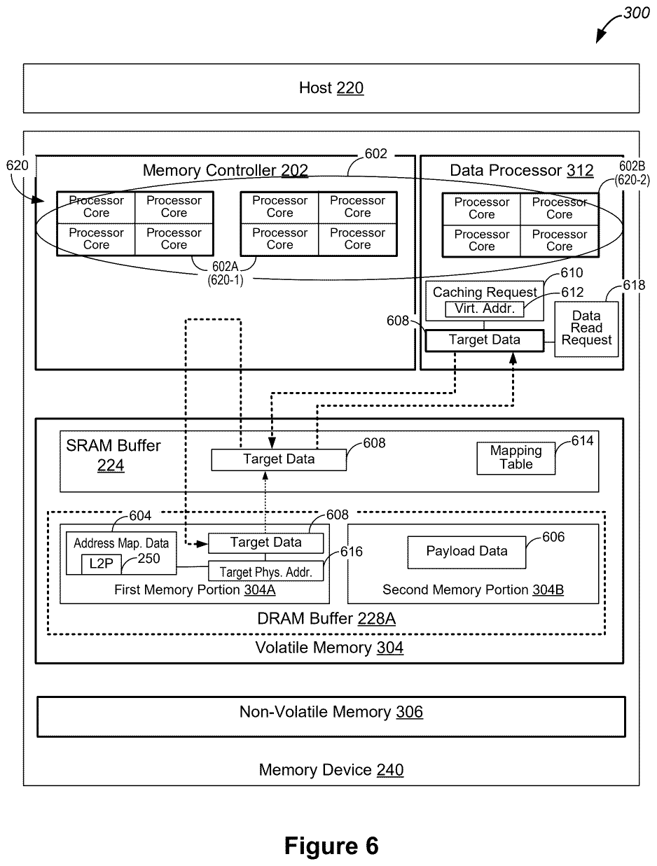

FIG. 6 is a block diagram of an example electronic system 300 that shares volatile memory space to facilitate in-memory data processing in a memory device 240, in accordance with some embodiments. The electronic system 300 includes a memory device 240 (e.g., an SSD) coupled to a host 220. The memory device 240 includes a plurality of processor cores 602, a volatile memory 304, and a non-volatile memory 306. The volatile memory 304 of each memory device 240 further includes an SRAM buffer 224 and a DRAM buffer 228A and is configured to store data temporarily. The non-volatile memory 306 (e.g., an SSD) includes a plurality of memory channels 204 configured to store data independently of whether the electronic system 300 is decoupled from a power source.

The electronic system 300 allocates a first subset of processor cores 602A to perform a plurality of memory access and management functions of a memory controller 202, and a second subset of processor cores 602B to perform a plurality of in-memory data processing functions of as a data processor 312. In some embodiments, an embedded operating system (e.g., Linux OS) is executed in the data processor 312 to perform the plurality of in-memory data processing functions. The volatile memory 304 is partitioned to a first memory portion 304A for storing address mapping data 604 temporarily for the memory controller 202 and a second memory portion 304B for storing payload data 606 (e.g., pages 512 and 525 in FIGS. 5A-5C) temporarily for the data processor 312. In some embodiments, the volatile memory 304 includes an SRAM buffer 224 and a DRAM buffer 228A (FIG. 2), and the DRAM buffer 228A is partitioned to the first memory portion 304A and the second memory portion 304B.

In some embodiments, the data processor 312 issues a caching request 610 for storing target data 608 (e.g., page 512) temporarily in the volatile memory 304. the data processor 312 determines that the second memory portion 304B associated with the data processor 312 has insufficient memory space to store the target data 608. In response to the caching request 610, in accordance with a determination that the second memory portion 304B has insufficient memory space, the electronic system 300 stores the target data 608 in the first memory portion 304A via the memory controller 202. In some embodiments, the target data 608 have a predefined data size granularity, e.g., is measured in a size of a memory page 210. Examples of a size of a memory page 210 is 4 KB, 16 KB, and 64 KB. A minimum size of the target data 608 is the size of the memory page 210.

In some embodiments, the caching request 610 further includes a virtual address 612 of the target data. After the target data 608 are stored in the first memory portion 304A, the data processor 312 updates a mapping table 614 associating the virtual address 612 of the target data 608 with a target physical address 616 within the first memory portion 304A of the volatile memory 304. The mapping table 614 includes a page directory 516 and a plurality of page tables 518 (FIGS. 5A-5C). In some situations, the mapping table 614 is stored in the SRAM buffer 224. In some situations, the mapping table 614 is stored in a dedicated mapping cache (not shown). Alternatively, in some situations, the mapping table 614 is stored in the second memory portion 304B allocated to the data processor 312 within the DRAM buffer 228A. In other words, in some embodiments, the mapping table 614 is stored in one of the SRAM and the second memory portion 304B of the DRAM buffer 228A.

Further, in some embodiments, the data processor 312 generates a data read request 618 for extracting the target data 608, and the data read request 618 includes the virtual address 612 of the target data 608. In response to the data read request 618, the data processor 312 determines that the target data 608 is stored in the first memory portion 304A based on the mapping table 614 and extracts the target data 608 from the first memory portion 304A based on the target physical address 616. In some embodiments, given the known target physical address 616, the data processor 312 extracts the target data 608 from the non-volatile memory 306 without involving the memory controller 202.

In some embodiments, the plurality of processor cores 602 are grouped into a plurality of clusters 620. The first subset of processor cores 602A of the memory controller 202 correspond to a first set of one or more clusters 620-1, and the second subset of processor cores 602B of the data processor 312 correspond to a second set of one or more clusters 620-2. In an example, the memory device 240 includes 12 processor cores 602 grouped into 3 clusters 620. Two clusters 620-1 are allocated to form the memory controller 202, performing the plurality of memory access and management functions. A remainder cluster 620-2 is allocated to form the data processor 312, performing the plurality of in-memory data processing functions. The mapping table 614 is stored in a cluster-level L3 cache associated with the data processor 312. The L3 cache may be implemented in the SRAM buffer 224 and shared by the first set of clusters 620-1 and the second set of one or more clusters 620-2.

Further, in some embodiments, the electronic system 300 stores the target data 608 in the first memory portion 304A via the memory controller 202. More specifically, the data processor 312 stores the target data 608 in the cluster-level L3 cache (e.g., the SRAM buffer 224). The memory controller 202 extracts the target data from the cluster-level L3 cache and stores the target data 608 in the first memory portion 304A.

In some embodiments, when the electronic system 300 stores the target data 608 in the first memory portion 304A, a data storage request including the target data is extended from the data processor 312 to the memory controller 202. In response to the data storage request, the memory controller 202 stores the target data 608 in the first memory portion 304A. After the target data 608 are stored, the data processor 312 receives a message indicating that the target data 608 is stored in the target physical address 616 in the first memory portion 304A. In some embodiments, the target data 608 are further stored in the non-volatile memory 306 by the memory controller 202.

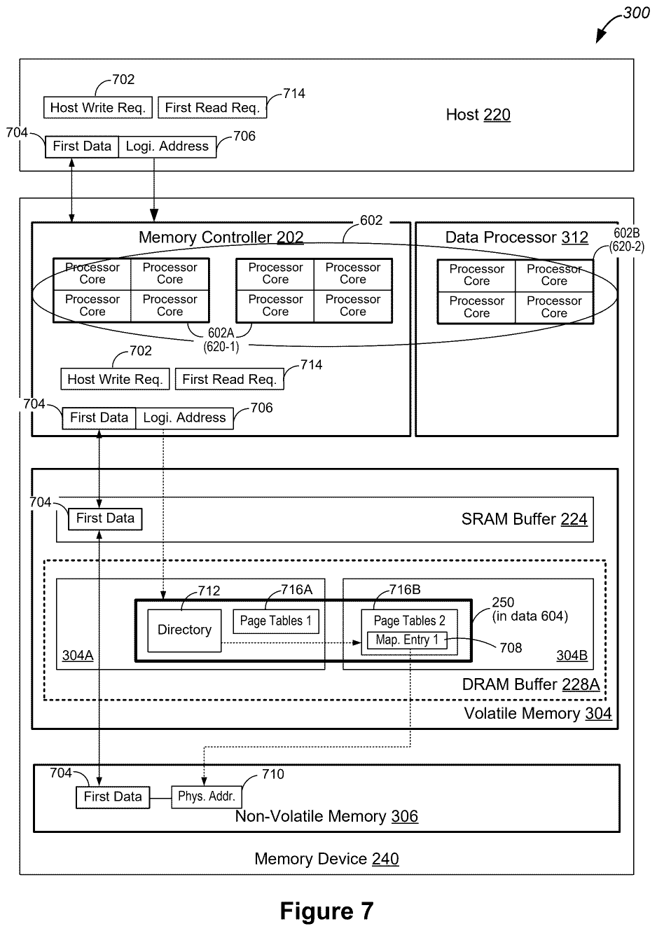

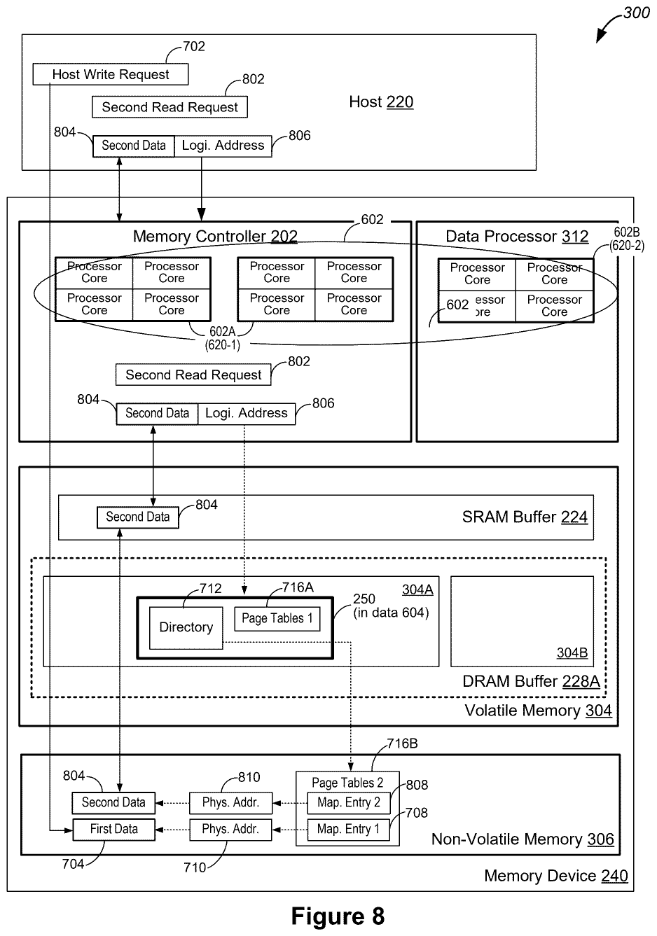

FIG. 7 is a block diagram of an example electronic system 300 that shares volatile memory space to facilitate storage functions of a memory device 240, in accordance with some embodiments. The electronic system 300 includes a memory device 240 (e.g., an SSD) coupled to a host 220. The memory device 240 includes a plurality of processor cores 602, a volatile memory 304, and a non-volatile memory 306. The electronic system 300 allocates a first subset of processor cores 602A to perform a plurality of memory access and management functions of a memory controller 202, and a second subset of processor cores 602B to perform a plurality of in-memory data processing functions of as a data processor 312. The volatile memory 304 is partitioned to a first memory portion 304A for storing address mapping data 604 temporarily for the memory controller 202 and a second memory portion 304B for storing payload data 606 temporarily for the data processor 312. In some embodiments, the volatile memory 304 includes an SRAM buffer 224 and a DRAM buffer 228A (FIG. 2), and the DRAM buffer 228A is partitioned to the first memory portion 304A and the second memory portion 304B.

In some embodiments, the memory device 240 is coupled to a host device 220. The memory controller 202 receives a host write request 702 including first data 704 and a logical address 706 of the first data 704. The memory controller 202 determines that the first memory portion 304A has insufficient memory space to store a first mapping entry 708 translating the logical address 706 of the first data 704 to a physical address 710 of the first data 704. In response to the host write request 702, in accordance with a determination that the first memory portion 304A has insufficient memory space, the memory controller 202 determines a physical address 710 of the first data 704 stored in the non-volatile memory 306 for storing the first data 704, and stores the first mapping entry 708 (e.g., including the physical address 710 of the first data 704) in the second memory portion 304B. The first data 704 are stored in the non-volatile memory 306 based on the physical address 710 of the first data 704.

Further, in some embodiments, the address mapping data 604 include an L2P table 250 further having a directory 712. In response to the host write request 702, in accordance with a determination that the first memory portion 304A has insufficient memory space to store the first mapping entry 708, the memory controller 202 updates the directory 712 of the L2P table 250 stored in the first memory portion 304A to point to the first mapping entry 708 stored in the second memory portion 304B.

In some embodiments, the memory controller 202 receives a first read request 714 for the first data 704, and the first read request 714 includes the logical address 706 of the first data 704. In response to the first read request 714, the memory controller 202 determines that the physical address of the first data 704 is stored in the second memory portion 304B associated with the data processor 312. The memory controller 202 obtains the physical address 710 of the first data 704 from the second memory portion 304B and extracts the first data 704 from the non-volatile memory 306 based on the physical address 710 of the first data 704.

In some embodiments, the volatile memory 304 includes an SRAM buffer 224 and a DRAM buffer 228A (FIG. 2), and the DRAM buffer 228A is partitioned to the first memory portion 304A and the second memory portion 304B. The first data 704 are temporarily stored in the SRAM buffer 224 before the first data 704 are stored in the non-volatile memory 306 based on the physical address 710 of the first data 704.

Referring to FIG. 7, in some embodiments, the L2P table 250 applied by the memory controller 202 includes a directory 712 and a plurality of page tables 716A and 716B. Each page table 716A or 716B includes a plurality of mapping entries mapping logical addresses of a host application to physical addresses in the non-volatile memory 306. The plurality of mapping entries include the first mapping entry 708 translating the logical address 706 of the first data 704 to the physical address 710 of the first data 704. The plurality of page tables includes a first set of page tables 716A and a second set of page tables 716B. The first memory portion 304A allocated to the memory controller 202 stores the directory 712 and the first set of page tables 716A, and the second set of page tables 716B including the first mapping entry 708 is stored in the second memory portion 304B, which is allocated to implement the data processing functions of the data processor 312 of the memory device 240.

FIG. 8 is a block diagram of an example electronic system 300 that stores one or more-page tables 716B in a non-volatile memory 306 in a memory device 240, in accordance with some embodiments. In some embodiments, the memory device 240 is coupled to a host device 220. The memory controller 202 receives a host write request 702 including first data 704 and an associated logical address 706 of the first data 704. The memory controller 202 determines that the first memory portion 304A has insufficient memory space to store a first mapping entry 708 translating the logical address 706 of the first data 704 to a physical address 710 of the first data 704. In response to the host write request 702, the memory controller 202 determines a physical address 710 in the non-volatile memory 306 for storing the first data 704 and stores the first mapping entry 708 in the non-volatile memory 306 directly. The first data 704 are stored in the non-volatile memory 306 based on the physical address 710 of the first data 704. Further, in some embodiments, the address mapping data 604 include an L2P table 250 further having a directory 712. In response to the host write request 702, the memory controller 202 updates the directory 712 of the L2P table 250 stored in the first memory portion 304A to point to the first mapping entry 708 stored in the non-volatile memory 306.

In some embodiments, the address mapping data 604 include an L2P table 250. The memory controller 202 receives a second read request 802 for second data 804, and the second read request 802 includes a logical address 806 of the second data 804. In response to the second read request 802, the memory controller 202 searches the L2P table 250 based on the logical address 806 of the second data 804 to identify a second mapping entry 808. The second mapping entry 808 translates the logical address 806 of the second data 804 to a physical address 810 of the second data 804 in the non-volatile memory 306. The memory controller 202 extracts the second data 804 from the non-volatile memory 306 based on the physical address 810 of the second data 804.

Referring to FIG. 8, in some embodiments, the L2P table 250 applied by the memory controller includes a directory 712 and a plurality of page tables 716. The plurality of page tables 716 includes a first set of page tables 716A and a second set of page tables 716B. The first memory portion 304A allocated to the memory controller 202 stores the directory 712 and the first set of page tables 716A, and the second set of page tables 716B including the first mapping entry 708 is stored in the non-volatile memory 306.

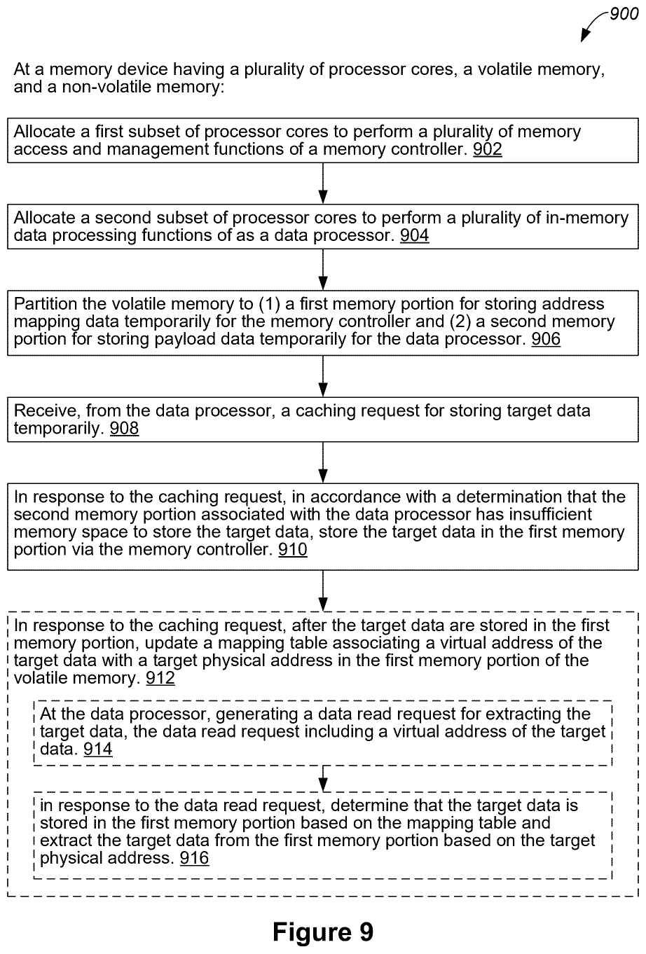

FIG. 9 is a flow diagram of an example method 900 for managing volatile memory space in a memory device 240 (e.g., a CSD), in accordance with some embodiments. The method 900 is implemented by a memory device 240 having a plurality of processor cores 602, a volatile memory 304, and a non-volatile memory 306. The memory device 240 allocates (operation 902) a first subset of processor cores 602A to perform a plurality of memory access and management functions of a memory controller 202, and allocates (operation 904) a second subset of processor cores 602B to perform a plurality of in-memory data processing functions of as a data processor 312. The volatile memory 304 is partitioned (operation 906) to a first memory portion 304A for storing address mapping data 604 temporarily for the memory controller 202 and a second memory portion 304B for storing payload data temporarily for the data processor 312. A caching request 610 is received (operation 908) from the data processor 312 for storing target data 608 temporarily. In response to the caching request 610, in accordance with a determination that the second memory portion 304B associated with the data processor 312 has insufficient memory space to store the target data 608, the data processor 312 stores (operation 910) the target data 608 in the first memory portion 304A via the memory controller 202.

In some embodiments, in response to the caching request 610, after the target data 608 are stored in the first memory portion 304A, the memory device 240 updates (operation 912) a mapping table 614 associating a virtual address 612 (VA) of the target data 608 with a target physical address 616 in the first memory portion 304A of the volatile memory 304. Further, in some embodiments, the data processor 312 generates (operation 914) a data read request 618 for extracting the target data 608, and the data read request 618 includes a virtual address 612 (VA) of the target data 608. In response to the data read request 618, the data processor 312 determines (operation 916) that the target data 608 is stored in the first memory portion 304A based on the mapping table 614 and extracts the target data 608 from the first memory portion 304A based on the target physical address 616 of the target data 608, e.g., without involving the memory controller 202.

In some embodiments, the plurality of processor cores are grouped into a plurality of clusters. The first subset of processor cores 602A of the memory controller 202 correspond to a first set of one or more clusters, and the second subset of processor cores 602B of the data processor 312 correspond to a second set of one or more clusters. The memory controller 202 and the data processor 312 share a cluster-level L3 cache.

In some embodiments, the memory device 240 is coupled to a host device. The memory controller 202 receives a host write request including first data 704 and a logical address 706 of the first data 704, and determines that the first memory portion 304A has insufficient memory space to store a first mapping entry translating the logical address 706 of the first data 704 to a physical address 710 of the first data 704. In response to the host write request, in accordance with a determination that the first memory portion 304A has insufficient memory space to store the first mapping entry, the memory device 240 determines the physical address 710 in the non-volatile memory 306 for storing the first data 704, stores the first mapping entry in one of the second memory portion 304B (FIG. 7) and the non-volatile memory 306 (FIG. 8), and stores the first data 704 in the non-volatile memory 306 based on the physical address 710 of the first data 704.

Further, in some embodiments, the memory device 240 (e.g., the memory controller 202) receives a first read request 702 for the first data 704, and the first read request 702 includes the logical address 706 of the first data 704. In response to the first read request 702, the memory controller 202 determines that the physical address 710 of the first data 704 is stored in the second memory portion 304B associated with the data processor 312, obtains the physical address 710 of the first data 704 from the second memory portion 304B, and extracts the first data 704 from the non-volatile memory 306 based on the physical address 710 of the first data 704.

In some embodiments, the address mapping data 604 include an L2P table 250. The memory controller 202 receives a second read request 802 for second data 804, the second read request 802 including a logical address 806 of the second data 804. In response to the second read request 802, the memory controller 202 searches the L2P table 250 based on the logical address 806 of the second data 804 to determine a physical address 810 of the second data 804, and extracts the second data 804 from the non-volatile memory 306 based on the physical address 810 of the second data 804.

Stated another way, in accordance with some embodiments of this application is at least a realization that there is a need to share buffer space between a memory controller and a data processor of a memory device using storage semantics. In some embodiments, an address space may be statically allocated to either of the memory controller and the data processor at a boot time, and onboard buffer space (e.g., DRAM, SRAM) of the CSD is dynamically shared by the generic memory functions of the memory controller and the data processing operations of the data processor. More specifically, in some embodiments, DRAM, SRAM, or both are shared by a host-interfacing NVMe firmware and an in-memory Linux compute environment in a memory device (e.g., an SSD). The address space is statically allocated to each side at the boot time. The NVMe firmware has a flash translation layer (FTL) table having a limited size, and is associated with addressable memory units on a firmware side. The Linux compute environment managed by the data processor has certain amount of DRAM space available for data staging and manipulation on a compute side. Under some circumstances, at any one point in time, either side may not fully utilize or require its static allocation of memory, offering a possibility of lending its unused buffer space to the other side.

Some implementations of this application are directed to sharing memory (e.g., DRAM and SRAM) between memory storage and compute functions dynamically, e.g., using established NVMe protocol semantics to share memory from a host. In some embodiments, an isolated NAND namespace used for Linux paging file, and a pathway is accelerated due to a shared memory architecture. Data may be moved into and out of a shared L3 cache using memcpy. In some embodiments, a memory device operates in a single level cell (SLC) mode, when the shared memory architecture is applied.

Memory is also used to store instructions and data associated with the method 900, and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 900.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

Some implementations of this application are directed to volatile memory resource sharing in a memory device (e.g., an SSD). Various examples of these aspects of the disclosure are described as numbered clauses (1, 2, 3, etc.) for convenience. These are provided as examples, and do not limit the subject technology.
Clause 1. A method for managing memory resources, comprising: at a memory device having a plurality of processor cores, a volatile memory, and a non-volatile memory: allocating a first subset of processor cores to perform a plurality of memory access and management functions of a memory controller; allocating a second subset of processor cores to perform a plurality of in-memory data processing functions of as a data processor; partitioning the volatile memory to (1) a first memory portion for storing address mapping data temporarily for the memory controller and (2) a second memory portion for storing payload data temporarily for the data processor; receiving, from the data processor, a caching request for storing target data temporarily; and in response to the caching request, in accordance with a determination that the second memory portion associated with the data processor has insufficient memory space to store the target data, storing the target data in the first memory portion via the memory controller.
Clause 2. The method of clause 1, further comprising: in response to the caching request, after the target data are stored in the first memory portion, updating a mapping table associating a virtual address of the target data with a target physical address in the first memory portion of the volatile memory.
Clause 3. The method of clause 2, further comprising, at the data processor: generating a data read request for extracting the target data, the data read request including a virtual address of the target data; and in response to the data read request, determining that the target data is stored in the first memory portion based on the mapping table and extracting the target data from the first memory portion based on the target physical address.
Clause 4. The method of clause 2 or 3, wherein the volatile memory includes a static random-access memory (SRAM) and a dynamic random-access memory (DRAM), and the DRAM is partitioned to the first memory portion and the second memory portion, wherein the mapping table is stored in one of the SRAM and the second memory portion of the DRAM.
Clause 5. The method of any of clauses 2-4, wherein: the plurality of processor cores are grouped into a plurality of clusters; the first subset of processor cores of the memory controller correspond to a first set of one or more clusters, and the second subset of processor cores of the data processor correspond to a second set of one or more clusters; and the mapping table is stored in a cluster-level L3 cache associated with the data processor.
Clause 6. The method of any of clauses 1-5, wherein: the plurality of processor cores are grouped into a plurality of clusters; the first subset of processor cores of the memory controller correspond to a first set of one or more clusters, and the second subset of processor cores of the data processor correspond to a second set of one or more clusters; and the memory controller and the data processor share a cluster-level L3 cache.
Clause 7. The method of clause 6, wherein storing the target data in the first memory portion via the memory controller further comprising: storing the target data in the cluster-level L3 cache by the data processor; extracting the target data from the cluster-level L3 cache by the memory controller; and storing the target data in the first memory portion by the memory controller.
Clause 8. The method of any of clauses 1-7, wherein storing the target data in the first memory portion via the memory controller further comprising: extending a data storage request including the target data from the data processor to the memory controller; storing the target data in the first memory portion via the memory controller; receiving, by the data processor, a message indicating that the target data is stored in a target physical address in the first memory portion.
Clause 9. The method of any of clauses 1-8, wherein the target data have a predefined data size granularity.
Clause 10. The method of any of clauses 1-9, wherein the memory device is coupled to a host device, the method further comprising, by the memory controller: receiving a host write request including first data and a logical address of the first data; determining that the first memory portion has insufficient memory space to store a first mapping entry translating the logical address of the first data to a physical address of the first data; and in response to the host write request, in accordance with a determination that the first memory portion has insufficient memory space to store the first mapping entry: determining a physical address of the first data in the non-volatile memory for storing the first data; storing the first mapping entry in one of the second memory portion and the non-volatile memory; and storing the first data in the non-volatile memory based on the physical address of the first data.
Clause 11. The method of clause 10, wherein the address mapping data include a logical-to-physical (L2P) table further having a directory, the method further comprising: in response to the host write request, in accordance with a determination that the first memory portion has insufficient memory space to store the first mapping entry, updating the directory of the L2P table stored in the first memory portion to point to the first mapping entry stored in the one of the second memory portion and the non-volatile memory.
Clause 12. The method of clause 10 or 11, further comprising, by the memory controller: receiving a first read request for the first data, the first read request including the logical address of the first data; and in response to the first read request: determining that the physical address of the first data is stored in the second memory portion associated with the data processor; obtaining the physical address of the first data from the second memory portion; and extracting the first data from the non-volatile memory based on the physical address of the first data.
Clause 13. The method of any of clause 10-12, further comprising the volatile memory includes an SRAM and a DRAM, which is partitioned to the first memory portion and the second memory portion, the method further comprising: temporarily storing the first data in the SRAM before the first data are stored in the non-volatile memory based on the physical address of the first data.
Clause 14. The method of any of clauses 1-13, wherein the address mapping data include an L2P table, the method further comprising, by the memory controller: receiving a second read request for second data, the second read request including a logical address of the second data; and in response to the second read request: searching the L2P table based on the logical address of the second data to determine a physical address of the second data; and extracting the second data from the non-volatile memory based on the physical address of the second data.
Clause 15. The method of clause 14, wherein the L2P table of the memory controller includes a directory, a first set of physical block addresses, and a second set of physical block addresses, and wherein the directory and the first set of physical block addresses are stored in the first memory portion, and the second of physical block addresses is stored in at least one of the second memory portion and the non-volatile memory.
Clause 16. The method of any of clauses 1-15, further comprising: executing an embedded operating system in the data processor, including performing the plurality of in-memory data processing functions.
Clause 17. A memory device, comprising having a plurality of processor cores, a volatile memory, and a non-volatile memory, wherein the memory device stores one or more programs comprising instructions for performing a method in any of clauses 1-16.
Clause 18. A non-transitory computer readable storage medium storing one or more programs, the one or more programs comprising instructions that, when executed by a memory device that includes a plurality of processor cores, a volatile memory, and a non-volatile memory, cause the memory device to perform a method in any of clauses 1-16.

### Host Memory Buffer (HMB) Usage of an In-Memory Data Processor

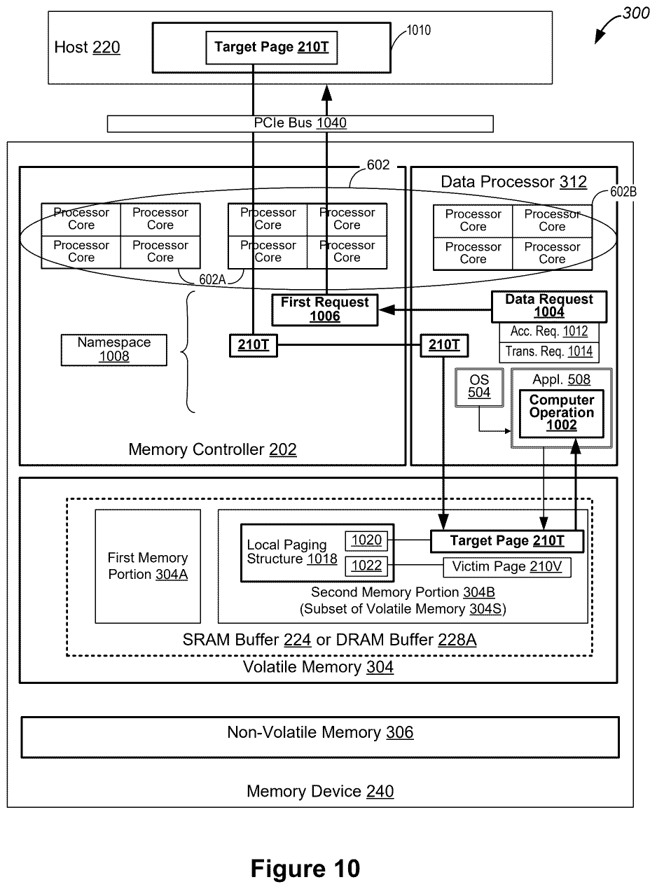

Some implementations of this application are directed to sharing memory between a host device 2420 and a memory device 240 using storage semantics (e.g., NVMe), e.g., in a multi-cluster shared memory system. In some embodiments, a volatile memory size of a memory device 240 is limited, and volatile memory 304 (e.g., DRAM 228A, SRAM 224) is statically partitioned. The volatile memory 304 may be shared between a memory controller 202 that implements host-facing NVMe firmware and a data processor 312 that executes an embedded operating system 506 (e.g., Linux OS). An address space of the volatile memory 304 may be statically allocated to the memory controller 202 and the data processor 312 at a boot time of the memory device 240. In some embodiments, a FTL table for the memory controller 202 may have a limited size, so do addressable NAND flash memory units on a firmware side. The FTL table is used to manage the interaction between the host device 220 and underlying NAND flash memory chips of the memory device 240. The FTL acts as a translator, handling the complexities of how data is stored and retrieved on the memory device 240 based on the FTL table. In some embodiments, for the data processor 312, the amount of volatile memory 304 allocated for data staging and manipulation is also limited on a corresponding compute side. In some implementations of this application, a subset of volatile memory 304S (FIG. 10) allocated to the data processor 312 may be expanded by sharing memory space provided by the host device 220, e.g., using established NVMe protocol semantics.

In some embodiments, an isolated DRAM backend namespace 1008 is implemented by the firmware of the memory controller 202, and exposed to the embedded operating system 506 of the data processor 312 for paging. In some embodiments, the subset of volatile memory 304S (FIG. 10) allocated to the data processor 312 may be expanded to a first memory portion 304A of the volatile memory 304 allocated to the memory controller 202, a host allocated memory (e.g. an HMB 1010), or a combination thereof. Further, in some embodiments, the firmware of the memory controller 202 is configured to translate accesses of the data processor 312 to the DRAM backend namespace 1008. For example, an internal memcpy command is used to copy a data block (e.g., a target page) from the first memory portion 304A allocated to the memory controller 202 to the subset of volatile memory 304S. In another example, a host read or write command is issued by the data processor based on a translation layer protocol (TLP) and a PCIe data transport protocol, allowing a data block (e.g., a target page) to be fetched from the host allocated memory (e.g., HMB 1010).

In some embodiments, an HMB is included the host device 240, which is coupled to one or more NVMe SSDs. Further, in some embodiments, a subset of the one or more NVMe SSDs does not include DRAM 228A, and uses the HMB, which is external to the SSDs and mounted on a motherboard, as a cache or a buffer. Alternatively, in some embodiments, a subset of the one or more NVMe SSDs includes DRAM 228A having a limited space, and the DRAM 228A may be supplemented by the HMB external to the SSDs and mounted on a motherboard.

In some embodiments, a memory system 200 includes a plurality of processor cores allocated to form a memory controller 202 and a data processor 312. The memory controller 202 executes firmware programs, and the data processor 312 executes an embedded operating system 506 (e.g., an embedded Linux system) that further implements one or more applications 506. The memory controller 202 and the data processor 312 have a cache coherent shared memory architecture, and are configured to exchanges data in a relatively fast rate. For example, the volatile memory 304 provides a Level 3 (L3) cache to be shared by, and accessible to both of, the memory controller 202 and the data processor 312. In some embodiments, the memory controller 202 and the data processor 312 have or implement storage subsystems, and apply NVMe semantics to access their allocated volatile memory 304 or supplemental memory space (e.g., HMB 1010 of the host device 220). In some embodiments, the memory controller 202 and the data processor 312 may leverage a hot plugging virtual memory that is enabled and disabled while a virtual machine is running. In some embodiments, the memory controller 202 and the data processor 312 may use the HMB (e.g., a large amount of DRAM space of the host device 220) using a PCIe bus 1040 (FIG. 10). Compared with adding extra volatile memory space in a memory device 240, supplementing the volatile memory 304 with the HMB 1010 of the host device 220 is a cost-efficient solution that improves overall performance of the memory device 240. By these means, a volatile memory capacity associated with the embedded operating system 504 may be increased by paging to a non-volatile memory 306 via an internal pathway or by dynamically sharing internal or external memory using known protocols (e.g., PCIe, NVMe) and MMU capabilities.

FIG. 10 is a block diagram of another example electronic system 300 that shares volatile memory space (e.g., an HMB of a host device 220) to facilitate in-memory data processing in a memory device 240, in accordance with some embodiments. The memory device 240 includes a plurality of processor cores 602, a volatile memory 304, and a non-volatile memory 306. The volatile memory 304 of the memory device 240 further includes an SRAM buffer 224 or a DRAM buffer 228A, and is configured to store data temporarily. The non-volatile memory 306 (e.g., NAND flash memory cells) includes a plurality of memory channels 204 configured to store data independently of whether the electronic system 300 is decoupled from a power source. The electronic system 300 allocates a first subset of processor cores 602A to perform a plurality of memory access and management functions of a memory controller 202, and a second subset of processor cores 602B to perform a plurality of in-memory data processing functions of as a data processor 312. In some embodiments, an embedded operating system (e.g., Linux OS) is executed in the data processor 312 to perform the plurality of in-memory data processing functions. The volatile memory 304 is partitioned to a first memory portion 304A for storing address mapping data 604 temporarily for the memory controller 202 and a second memory portion 304B for storing payload data 606 (e.g., pages 512 and 525 in FIGS. 5A-5C) temporarily for the data processor 312. In some embodiments, the volatile memory 304 includes an SRAM buffer 224 and a DRAM buffer 228A (FIG. 2), and the DRAM buffer 228A is partitioned to form the first memory portion 304A and the second memory portion 304B. Stated another way, a subset of volatile memory 304S (e.g., the second memory portion 304B) is allocated to the data processor 312.

In some embodiments, the memory device 240 determines that a target page 210T is not stored in the subset of volatile memory 304S (e.g., the second memory portion 304B) allocated to the data processor 312 and obtains the target page 210T from a host memory buffer (HMB) 1010. The target page 210T is then stored in the subset of volatile memory 304S (e.g., the second memory portion 304B) allocated to the data processor 312. The data processor 312 is configured to implement a computer operation 1002 based on the target page 210T stored in the subset of volatile memory 304S.

In some embodiments, when the memory device 240 obtains the target page 210T from the HMB 1010, the data processor 312 sends a data request 1004 for the target page 210T to the memory controller 202. In response to the data request 1004, the memory controller 202 fetches the target page 210T from the HMB, and provides the target page 210T to the data processor 312, which further stores the data processor 312 in the subset of volatile memory 304S temporarily.

In some embodiments, in accordance with a Non-Volatile Memory express (NVMe) storage access and transport protocol, the memory device 240 sends a first request to a host device 240 coupled to the memory device 240 via a Peripheral Component Interconnect Express (PCIe) bus 1040, and receives the target page 210T from the host device via the PCIe bus 1040. Stated another way, in some embodiments, the PCIe bus 1040 is a communication bus 140 (FIG. 1) that communicates data according to a PCIe data transfer protocol.

In some embodiments, in accordance with a NVMe storage access and transport protocol, an isolated DRAM backend namespace 1008 is implemented by the memory controller 202 to manage paging for the data processor 312. For example, a plurality of pages are stored in the subset of volatile memory 304S according to the isolated DRAM backend namespace 1008, where a victim page is selected the plurality of pages to create space for storing the target page 210T in the subset of volatile memory 304S. Further, in some embodiments, the data processor 312 executes an embedded operating system 504. The data processor 312 issues a memory access request 1012 for the target page 210T, and translates the memory access request 1012 to the DRAM backend namespace 1008 to generate a translated request 1014 for the target page 210T. Additionally, in some embodiments, the translated request 1014 includes a host read or write command that complies with a translation layer protocol (TLP). The TLP is a packet level format for exchanging information across the PCIe bus 1040. In some embodiments, the host read or write command is communicated from the memory device 240 to the host device 220 via a PCIe bus 1040. The host read or write command includes a host memory address and a size of the target page 210T or the victim page 210V. The host device 220 may respond to a host read request with the target page 210T in one or more completions containing the target page 210T, extracting the target page 210T from the HMB 1010 and providing the target page 210T to be stored in the subset of volatile memory 304S. The host device 220 may respond to a host write request by writing the victim page 210V into the HMB 1010. Conversely, in some embodiments, the translated request 1014 includes an internal memcpy command, which is a standard library function in C and C++ used for copying a block of memory from a source location to a destination location. The target page 210T may be copied from the first memory portion 304A allocated to the memory controller 202 to the subset of volatile memory 304S.

In some embodiments, the subset of volatile memory 304S further stores a local paging structure 1018. After storing the target page, the memory device 240 creates a target mapping entry 1020 in the local paging structure 1018, and the target mapping entry 1020 maps a target logical address LA of the target page 210T to a target physical address PA of the target page 210T in the subset of volatile memory 304S.

In some embodiments, prior to storing the target page 210T in the subset of volatile memory 304S, the memory device already caches a plurality of pages 210 to be used by the data processor 312 in the subset of volatile memory 304S. To store the target page 210T, the memory device 240 identifies a victim page 210V in the plurality of pages 210 stored in the subset of volatile memory 304S, and the target page 210T is stored in place of the victim page 210V. In some embodiments, the victim page 210V is moved to the HMB 1010. The victim page 210V is provided to the host device 220, and the host device 220 stores the victim page 210V in the HMB 1010 before the memory device 240 stores the target page 210T in the subset of volatile memory 304S.

In some embodiments, the subset of volatile memory 304S further stores a local paging structure 1018 including a victim mapping entry 1022 mapping a victim logical address of the victim page 210V to a victim physical address of the victim page 210V in the subset of volatile memory 304S. The memory device 240 unmaps, in the local paging structure 1018, the victim logical address of the victim page 210V to the victim physical address of the victim page 210V in the subset of volatile memory 304S.

In some embodiments, the local paging structure 1018 stored in the subset of volatile memory 304S includes a plurality of page entries that map logical addresses of the plurality of pages to physical addresses of the plurality of pages in the subset of volatile memory. The memory device 240 determines the target page 210T is not stored in the subset of volatile memory 304S in accordance with a determination that the target page 210T is unmapped in the local paging structure 1018.

In some embodiments, when the target page 210T is not stored in the subset of volatile memory 304S, the memory device 240 causes a page fault, and routes a data request 1004 for the target page 210T through a kernel paging subsystem. The target page 210T is identified in an HMB page pool of the host device, and obtained from the HMB 1010 via the memory controller 202.

In some embodiments, the data processor 312 executes an application 508 in a memory operating system 506. The data processor 312 accesses the target page 510T in the subset of volatile memory 304S and implements the computer operation 1002 on the target page 210T. Further, in some embodiments, the target page 210T has a target logical address in an application address space associated with the application 508, and the target logical address is mapped to a target physical address in the subset of volatile memory 304S (e.g., in the local paging structure 1018). Alternatively, in some embodiments not shown, the target page 210 is associated with an embedded operating system 506. The data processor 312 accesses the target page 210T stored in the subset of volatile memory 304S to run the embedded operating system 506.

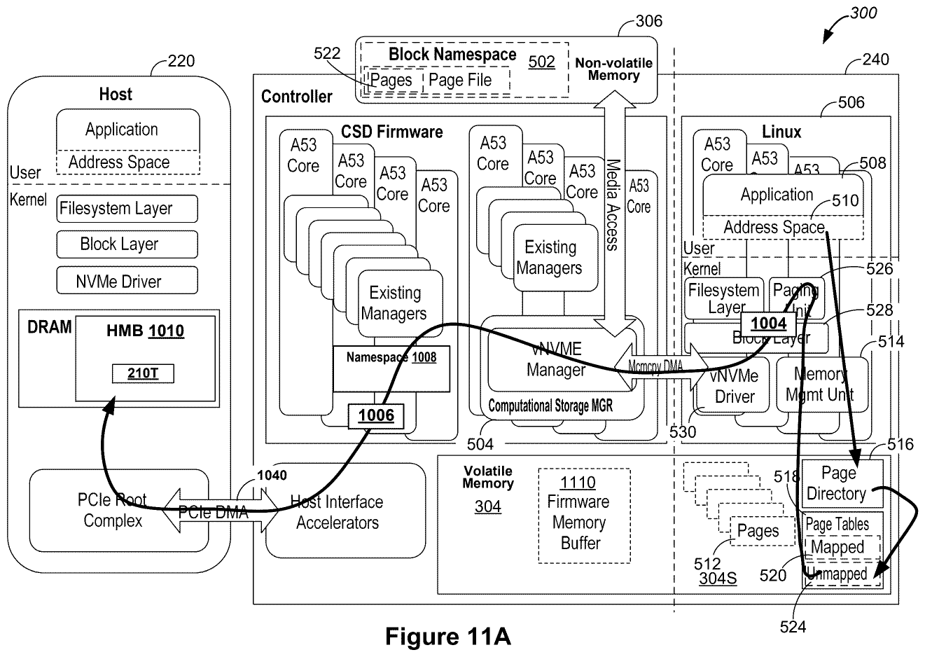

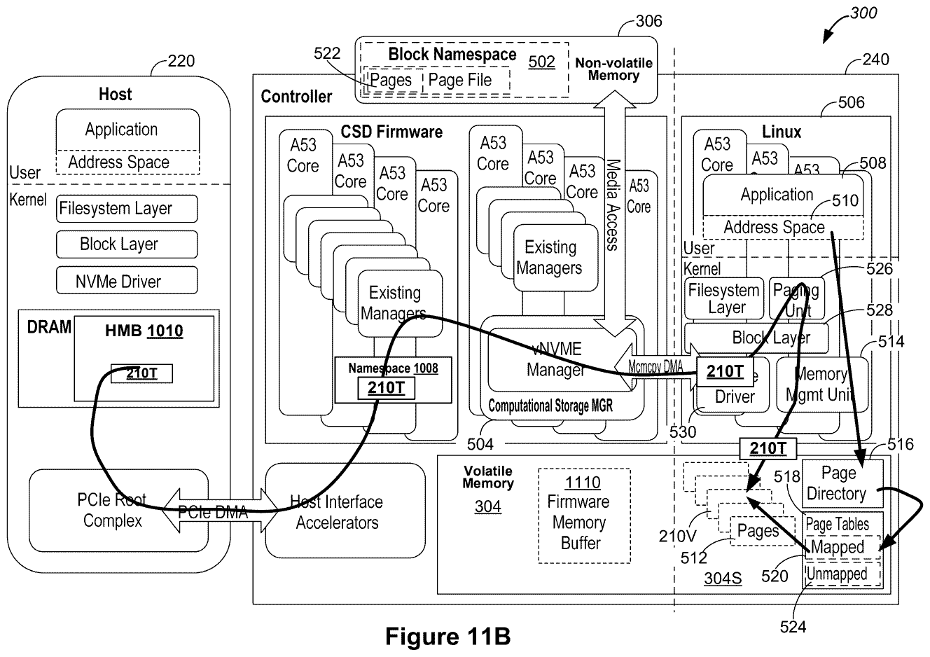

FIGS. 11A and 11B are block diagrams of an example electronic system 300 that supplements a subset of volatile memory 304S allocated to a data processor 312 with an HMB 1010 of a host device 220, in accordance with some embodiments. The electronic system 300 includes a memory device 240 (e.g., an SSD) coupled to the host 220. The memory device 240 further includes a storage manager 504 and a Linux compute system 506. Some implementations of this application are directed to a shared memory architecture in which volatile memory 304 (e.g., DRAM 228A, SRAM 224) is shared between memory storage functions and compute functions of the memory device 240, e.g., using established NVMe protocol semantics. A DRAM backend namespace 1008 may be isolated and used for paging a target page 210T for the Linux compute system 506, thereby providing an accelerated pathway due to the shared memory architecture.

In some embodiments, the Linux compute system 506 executes an application 508 having an address space 510 on an application level. The address space 510 includes a plurality of address space mappings to associate virtual addresses of the application 508 to physical addresses of pages 512 stored in the volatile memory 304 (e.g., the DRAM buffer 228A). A memory management unit (MMU) 514 is applied in an operating system kernel to configure the address space mappings of the address space 510 associated with the page 512 stored in the DRAM buffer 228A. In some embodiments, the MMU 514 identifies a physical page 512 stored in the volatile memory 304 (e.g., the DRAM buffer 228A) in response to a request for an application page of the application 508 corresponding to a logical address. More specifically, the MMU 514 checks a page directory 516 to identify a page table 518 to identify the physical page 512 among a mapped portion 520 storing physical addresses of locally mapped pages (e.g., including a physical address of the page 512 within the DRAM buffer 228A).

Referring to FIG. 11A, in some embodiments, the mapped portion 520 includes mapping entries corresponding to the plurality of pages 512 stored locally in the second memory portion 304B. The unmapped portion 520 corresponds to pages that are not stored locally in the second memory portion 304B. A page fault happens when no physical page 512 stored in a subset of volatile memory 304S, which is allocated to the data processor 312, is found for a logical address of a target page 210T requested by the application 508. A page fault causes a page table walk to identify the target page 210T stored in the HMB 1010 of the host device 220 based on logical-to-physical (L2P) mapping. More specifically, in some embodiments, the application 508 issues a request for the target page 210T, causing a page fault. Information of the target page 210T is stored in an unmapped portion 524 of the page tables 518. Transaction is routed through a kernel paging subsystem to extract the information of the target page 210T from the unmapped portion 524 and identify the target page 210T in a page pool of the HMB 1010 of the host device 220 based on the extracted information of the target page 210T. In some embodiments, the page directory 516 and the page table 518 are stored in the subset of volatile memory 304S (e.g., part of an SRAM buffer 224 or the DRAM buffer 228A).

In some embodiments, after the paging unit 526 determines that the target page 210T is stored in the HMB 1010 of the host device 220, the page unit 526 issues a data request 1004 to the storage manager 504 of the memory controller 202. The data request 1004 is translated to a first request 1006 that is communicated to the host device 220 via a PCIe bus 1040.

Referring to FIG. 11B, in some embodiments, the target page 210T is copied from the HMB 1010 of the host device 220 into a victim cache location (e.g., as a victim page 210V) in the subset of volatile memory 304S and mapped into the address space 510 associated with the application 508. A page fault handler returns, e.g., to identify information of the victim page 210V (e.g., a physical address of the victim cache location) in the mapped portion 520 in the page tables 518. The application 508 can freely access the pages (e.g., page 512) identified in the mapped portion 520. In some embodiments, before the target page 210T is copied into the victim cache location for the victim page 210V, the victim page 210V is copied to the HMB 1010, the block namespace 502 of the non-volatile memory 306, or a firmware memory buffer 1110, while a location of the victim page 210 is added into the unmapped portion 524 of the page tables 518. In some embodiments, the kernel paging subsystem includes one or more of the MMU 514, a paging unit 526, a block layer 528, and a driver 530. The kernel paging subsystem is implemented by a data processor 312 of the memory device 240, and collaborates with the storage manager 504 implemented by a memory controller 202.

In some implementation, an isolated DRAM backend namespace 1008 is implemented by the firmware of the memory controller 202 and exposed to the Linux compute system 506 for paging. The volatile memory 304 may correspond to the DRAM buffer 228A or the SRAM buffer 224. In some embodiments, a subset of the volatile memory 304S is allocated to the Linux compute system 506 executed by the data processor 312, and supplemented by the HMB 1010 of the host device 220. In some embodiments, a subset of the volatile memory 304S is allocated to the Linux compute system 506 executed by the data processor 312, and supplemented by the non-volatile memory 306, the HMB 1010 of the host device 220, the firmware memory buffer, or a combination thereof. The firmware of the memory controller 202 translates access requests of the Linux compute system 506 in the DRAM backend namespace.

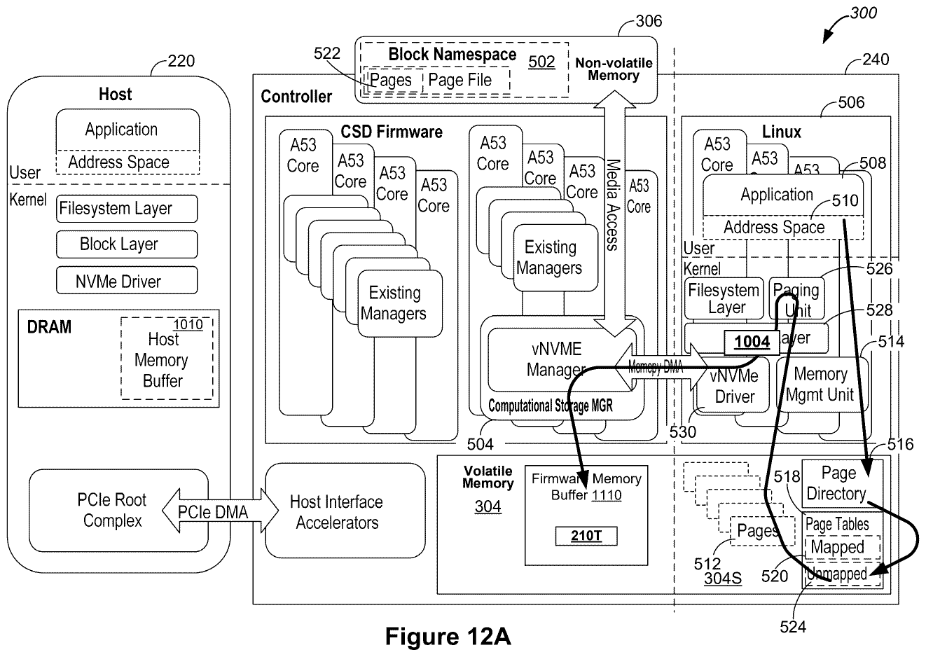

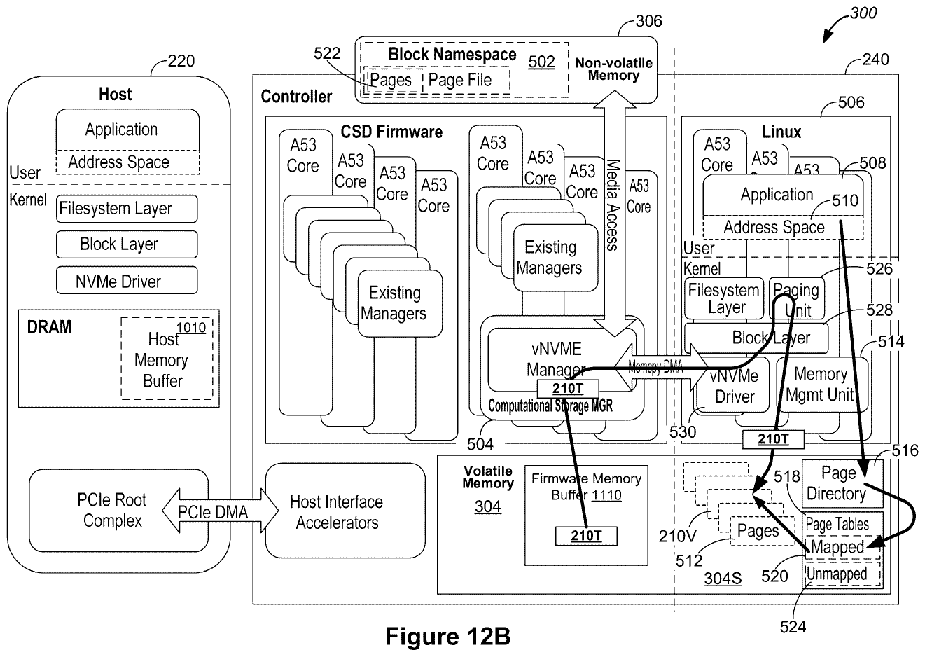

FIGS. 12A and 12B are block diagrams of another example electronic system 300 that supplements a subset of volatile memory 304S allocated to a data processor 312 with a firmware memory buffer 1110 allocated to a memory controller 202, in accordance with some embodiments. Some implementations of this application are directed to a shared memory architecture in which volatile memory 304 (e.g., DRAM 228A, SRAM 224) is shared between memory storage functions (e.g., of the memory controller 202) and compute functions (e.g., of the data processor 312) of the memory device 240, e.g., using established NVMe protocol semantics. The volatile memory 304 includes a subset of volatile memory 304S allocated to the data processor 312 and a firmware memory buffer 1110 allocated to the memory controller 202.

Referring to FIG. 12A, in some embodiments, the mapped portion 520 includes mapping entries corresponding to the plurality of pages 512 stored locally in the second memory portion 304B. The unmapped portion 520 corresponds to pages that are not stored locally in the second memory portion 304B. A page fault happens when no physical page 512 stored in a subset of volatile memory 304S, which is allocated to the data processor 312, is found for a logical address of a target page 210T requested by the application 508. The page fault causes a page table walk to identify the target page 210T stored in the firmware memory buffer 1110 based on logical-to-physical (L2P) mapping. More specifically, in some embodiments, the application 508 issues a request for the target page 210T, causing a page fault because the target page 210T is not stored in the subset of volatile memory 304S. Information of the target page 210T is stored in an unmapped portion 524 of the page tables 518. Transaction is routed through a kernel paging subsystem to extract the information of the target page 210T from the unmapped portion 524 and identify the target page 210T in the firmware memory buffer 1110 allocated to the memory controller 202 based on the extracted information of the target page 210T. In some embodiments, after the paging unit 526 determines that the target page 210T is stored in the firmware memory buffer 1110, the page unit 526 issues a data request 1004 to the storage manager 504 of the memory controller 202.

Referring to FIG. 12B, in some embodiments, the target page 210T is copied from the firmware memory buffer 1110 into a victim cache location (e.g., as a victim page 210V) in the subset of volatile memory 304S and mapped into the address space 510 associated with the application 508. A page fault handler returns, e.g., to identify information of the victim page 210V (e.g., a physical address of the victim cache location) in the mapped portion 520 in the page tables 518. The application 508 can freely access the pages (e.g., page 512) identified in the mapped portion 520. In some embodiments, before the target page 210T is copied into the victim cache location for the victim page 210V, the victim page 210V is copied to the HMB 1010, the block namespace 502 of the non-volatile memory 306, or a firmware memory buffer 1110, while a location of the victim page 210 is added into the unmapped portion 524 of the page tables 518.

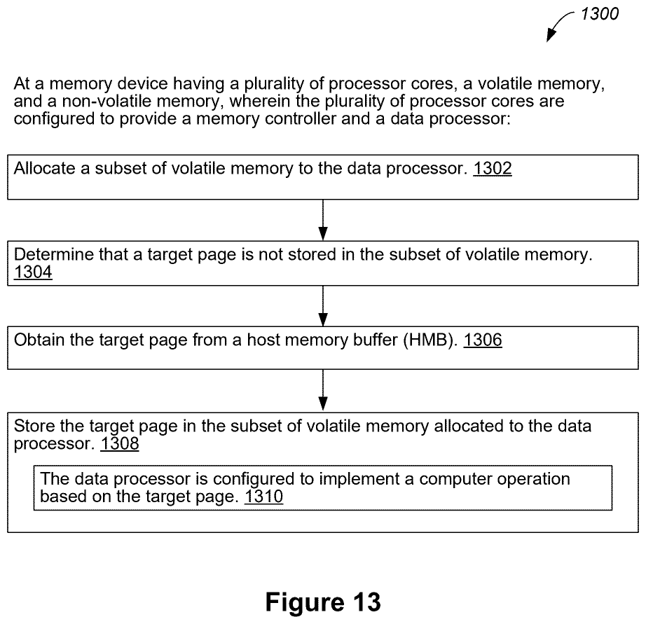

FIG. 13 is a flow diagram of an example method 1300 for managing volatile memory space in a memory device 240, in accordance with some embodiments. The method 1300 is implemented by a memory device 240 having a plurality of processor cores 602, a volatile memory 304, and a non-volatile memory 306. The plurality of processor cores 602 are configured to provide a memory controller 202 and a data processor 312. For example, the memory device 240 allocates a first subset of processor cores 602A (FIG. 10) to perform a plurality of memory access and management functions of the memory controller 202, and allocates a second subset of processor cores 602B (FIG. 10) to perform a plurality of in-memory data processing functions of the data processor 312. In some embodiments, the volatile memory 304 is partitioned to a first memory portion 304A (FIG. 10) for storing address mapping data temporarily for the memory controller 202 and a second memory portion 304B (FIG. 10) for storing payload data temporarily for the data processor 312. The second memory portion 304B corresponds a subset of volatile memory 304S allocated to the data processor 312.

In some embodiments, the memory device 240 allocates (operation 1302) the subset of volatile memory 304S to the data processor 312, and determines (operation 1304) that a target page 210T is not stored in the subset of volatile memory 304S. The memory device 240 obtains (operation 1306) the target page from a host memory buffer (HMB) of a host device 220 coupled to the memory device 240. The target page 210T is stored (operation 1308) in the target page 210T in the subset of volatile memory 304S allocated to the data processor 312, and the data processor 312 is configured to implement (operation 1310) a computer operation 1002 based on the target page 210T.

Some implementations of this application are directed to host memory buffer (HMB) usage of an in-memory data processor. Various examples of these aspects of the disclosure are described as numbered clauses (1, 2, 3, etc.) for convenience. These are provided as examples, and do not limit the subject technology.
Clause 1. A method for managing memory resources, comprising: at a memory device having a plurality of processor cores, a volatile memory, and a non-volatile memory, wherein the plurality of processor cores are configured to provide a memory controller and a data processor: allocating a subset of volatile memory to the data processor; determining that a target page is not stored in the subset of volatile memory; obtaining the target page from a host memory buffer (HMB); and storing the target page in the subset of volatile memory allocated to the data processor, wherein the data processor is configured to implement a computer operation based on the target page.
Clause 2. The method of clause 1, wherein obtaining the target page from the HMB further comprises: sending a data request for the target page from the data processor to the memory controller; and at the memory controller, in response to the data request: fetching the target page from the HMB; and providing the target page to the data processor.
Clause 3. The method of clause 1 or 2, wherein obtaining the target page from the HMB further comprises, in accordance with a Non-Volatile Memory express (NVMe) storage access and transport protocol: sending a first request to a host coupled to the memory device via a Peripheral Component Interconnect Express (PCIe) bus; and receiving the target page from the host via the PCIe bus.
Clause 4. The method of any of clauses 1-3, further comprising: in accordance with a NVMe storage access and transport protocol, implementing an isolated dynamic random-access memory (DRAM) backend namespace by the memory controller to manage paging for the data processor.
Clause 5. The method of clause 4, further comprising: executing an embedded operating system by the data processor, including issuing a memory access request for the target page; and translating the memory access request to the DRAM backend namespace to generate a translated request for the target page.
Clause 6. The method of clause 5, wherein the translated request includes a host memory access command that complies with a Transaction Level Protocol (TLP), the method further comprising: communicating the host memory access command via a PCIe bus coupled between the memory device and a host device.
Clause 7. The method of any of clauses 1-6, wherein the subset of volatile memory further stores a local paging structure, and the method further comprises: after storing the target page, creating a target mapping entry in the local paging structure, the target mapping entry mapping a target logical address of the target page to a target physical address of the target page in the subset of volatile memory.
Clause 8. The method of any of clauses 1-7, further comprising, prior to storing the target page: caching, in the subset of volatile memory, a plurality of pages to be used by the data processor.
Clause 9. The method of clause 8, further comprising, prior to storing the target page: identifying a victim page in the plurality of pages stored in the subset of volatile memory, wherein the target page is stored in place of the victim page.
Clause 10. The method of clause 9, further comprising storing, in the HMB, the victim page that is stored in the subset of volatile memory.
Clause 11. The method of clause 9 or 10, wherein the subset of volatile memory further stores a local paging structure including a victim mapping entry mapping a victim logical address of the victim page to a victim physical address of the victim page in the subset of volatile memory, the method further comprising: unmapping, in the local paging structure, the victim logical address of the victim page to the victim physical address of the victim page in the subset of volatile memory.
Clause 12. The method of any of clauses 8-11, wherein the subset of volatile memory further stores a local paging structure including a plurality of page entries that map logical addresses of the plurality of pages to physical addresses of the plurality of pages in the subset of volatile memory, and the method further comprises: determining that the target page is unmapped in the local paging structure to determine that the target page is not stored in the subset of volatile memory.
Clause 13. The method of any of clauses 1-12, further comprising, when the target page is not stored in the subset of volatile memory: causing a page fault; routing a data request for the target page through a kernel paging subsystem; and identifying the target page in an HMB page pool, wherein the target page is obtained from the HMB via the memory controller.
Clause 14. The method of any of clauses 1-13, further comprising, by the data processor: executing an application in a memory operating system, including accessing the target page in the subset of volatile memory and implementing the computer operation on the target page.
Clause 15. The method of clause 14, wherein the target page has a target logical address in an application address space associated with the application, and the target logical address is mapped to a target physical address in the subset of volatile memory.
Clause 16. The method of any of clauses 1-15, further comprising, by the data processor: accessing the target page stored in the subset of volatile memory by the data processor to run a memory operating system.
Clause 17. A memory device, comprising a plurality of processor cores configured to provide a memory controller and a data processor, a volatile memory, and a non-volatile memory, wherein the memory device stores one or more programs comprising instructions for performing a method in any of clauses 1-16.
Clause 18. A non-transitory computer readable storage medium storing one or more programs, the one or more programs comprising instructions that, when executed by a memory device having a memory controller, a data processor, a volatile memory, and a non-volatile memory, cause the memory device to perform a method in any of clauses 1-16.

### Multi-Tenant Volatile Memory Sharing in a Memory System

Some implementations of this application are directed to executing a hypervisor in a memory device to manage at least a plurality of memory resources for a plurality of virtual tenants (e.g., a data processor, a memory controller). The plurality of memory resources includes one or more portions of a volatile memory, a non-volatile memory, and a host memory buffer (HMB). In some embodiments, firmware of the memory device uses HMB semantics to reserve a DRAM region (e.g., an HMB) in a host device to be used by the data processor of the memory device. The data processor of the memory device may execute an embedded operating system (e.g., Linux), and the reserved HMB of the host device is exposed to the embedded operating system via one of a passthrough HMB memory semantic, an isolated namespace, and an VirtIO virtual machine interface. For example, the passthrough HMB memory semantic configures the HMB as a non-uniform memory access (NUMA) node exposing memory only (e.g., No processing cores are associated with the node) to a tenant or map the HMB directly into an address space. Accesses from the embedded operating system of the data processor are processed with two stages of translation (e.g., based on a TLP, by the hypervisor). For example, an access request is issued by the data processor, and translated into a TLP read or write request to access the HMB of the host device. In some embodiments, the isolated namespace is applied to identify a location of a target data (e.g., in the HMB), exit the victim memory page (e.g., to the HMB), and store the target data into a subset of volatile memory close to the data processor.

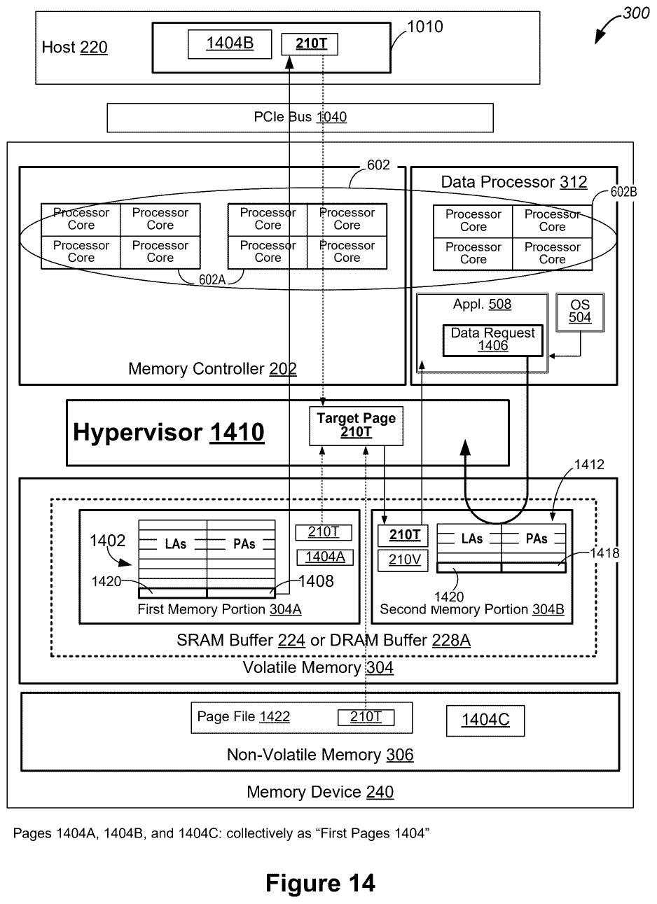

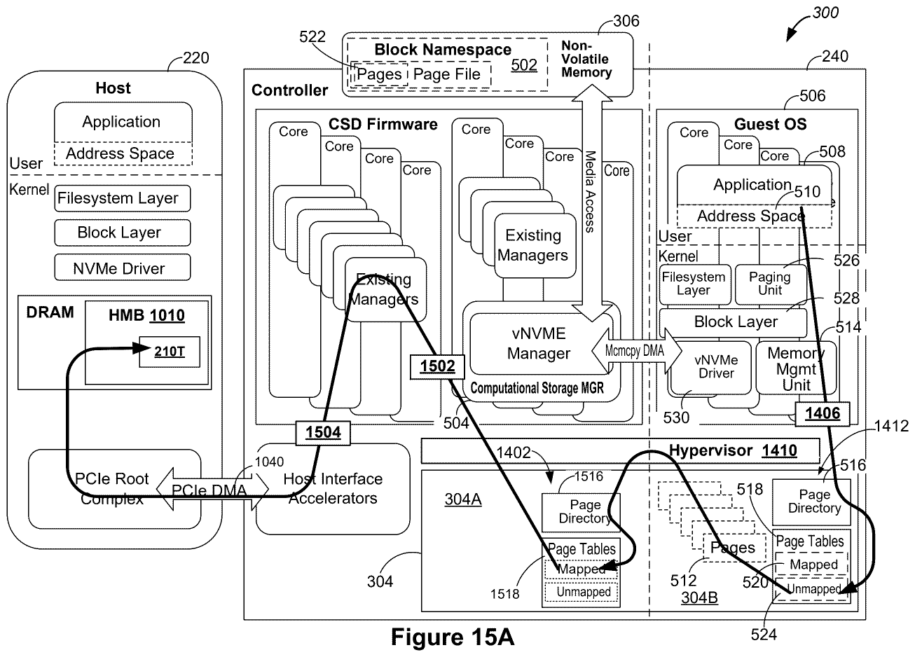

FIG. 14 is a block diagram of an example electronic system 300 that applies a hypervisor 1410 to manage memory resources and facilitate in-memory data processing in a memory device 240, in accordance with some embodiments. The memory device 240 includes a plurality of processor cores 602, a volatile memory 304, and a non-volatile memory 306. The volatile memory 304 of the memory device 240 further includes an SRAM buffer 224 or a DRAM buffer 228A, and is configured to store data temporarily. The non-volatile memory 306 (e.g., NAND flash memory cells) includes a plurality of memory channels 204 configured to store data independently of whether the electronic system 300 is decoupled from a power source. The electronic system 300 allocates a first subset of processor cores 602A to perform a plurality of memory access and management functions of a memory controller 202, and a second subset of processor cores 602B to perform a plurality of in-memory data processing functions of a data processor 312. In some embodiments, an embedded operating system 506 (e.g., Linux OS) is executed in the data processor 312 to perform the in-memory data processing functions. The volatile memory 304 is partitioned to a first memory portion 304A for storing address mapping data 604 temporarily for the memory controller 202 and a second memory portion 304B for storing data temporarily for the data processor 312.

In some embodiments, the first memory portion 304A stores a first paging structure 1402 that maps logical addresses LAs of a plurality of first pages 1404 (e.g., pages 1404A, 1404B, and 1404C) to physical addresses PAs in one or more of the first memory portion 304A, an HMB 1010 of a host device 220, and the non-volatile memory 306. The memory device 240 executes a hypervisor 1410 based on the first paging structure 1402. The memory device 240 receives a data request 1406 for a target page 210T from the data processor 312. In response to the data request, the hypervisor 1410 searches the first paging structure 1402 stored in the first memory portion 304A to identify a target location 1408 of the target page 210T. Based on the target location 1408, the target page 210T is obtained from one of the first memory portion 304A, the HMB 1010, and the non-volatile memory 306, and provided to the data processor 312, e.g., in response to the data request 1406 and for further processing.

In some embodiments, the memory device 240 is coupled to the host device 220 including a dynamic random-access memory (DRAM), and the DRAM is configured to provide the HMB 1010 using passthrough HMB memory semantics. In accordance with the passthrough HMB memory semantics, the DRAM of the host device 220 processes a memory request (e.g., corresponding to the data request 1406) received from the memory device 240 (e.g., from the data processor 312) by mapping a logical address included in the memory request to a buffer address in an HMB address range, converting the memory request to a PCIe-based request, and accessing the HMB 1010 to read or write one of the first pages 1404B in response to the memory request. Stated another way, the host device 220 traps the memory request (e.g., corresponding to the data request 1406) using the passthrough HMB semantics, and exits a trap after the one of the first pages 1404B is read from or written into the HMB 1010.

In some embodiments, the hypervisor 1410 configures the first memory portion 304A, the HMB 1010, and the non-volatile memory 306 to a plurality of paravirtualized memory devices. The paravirtualized memory devices are a high-performance virtualization technique that makes the embedded operating system 506 of the data processor 312 in a virtual environment and uses special hypercalls to communicate directly with the hypervisor 1410, bypassing emulated devices. This eliminates the overhead of device emulation by allowing the embedded operating system 506 and hypervisor 1410 to collaborate on memory management and other operations, resulting in faster input/output and increased efficiency for virtual machines. Further, in some embodiments, each paravirtualized memory device may include a VirtIO-based memory device. The first memory portion 304A, the HMB 1010, and the non-volatile memory 306 may collectively become a virtual machine memory of the data processor 312 of the memory device 240. The plurality of paravirtualized memory devices allow for dynamic memory management, and may support non-uniform memory access (NUMA) in which the paravirtualized memory devices are accessible to separate processing nodes (e.g., the memory controller 202, the data processor 312). In some embodiments, the first paging structure 1402 may be expanded or reduced to resize the virtual machine memory, when memory blocks are added or removed in the first memory portion 304A, the HMB 1010, and the non-volatile memory 306, thereby offering flexibility to the virtual machine memory that may be used to facilitate in-memory data processing of the data processor 312.

In some embodiments, the volatile memory 304 includes a second memory portion 304B distinct from the first memory portion 304A. The second memory portion 304A is allocated to the data processor 312. The second memory portion 304A may have a higher priority level to the data processor 312 than the first memory portion 304A, the HMB 1010, and the non-volatile memory 306. In response to the data request 1406 for a target page 210T, the memory device 240 searches the second memory portion 304B for the target page 210T. In accordance with a determination that the target page 210T is missing from the second memory portion 304A, the hypervisor 1410 further checks the first paging structure 1402 to search for the target page 210T in the first memory portion 304A, the HMB 1010, and the non-volatile memory 306.

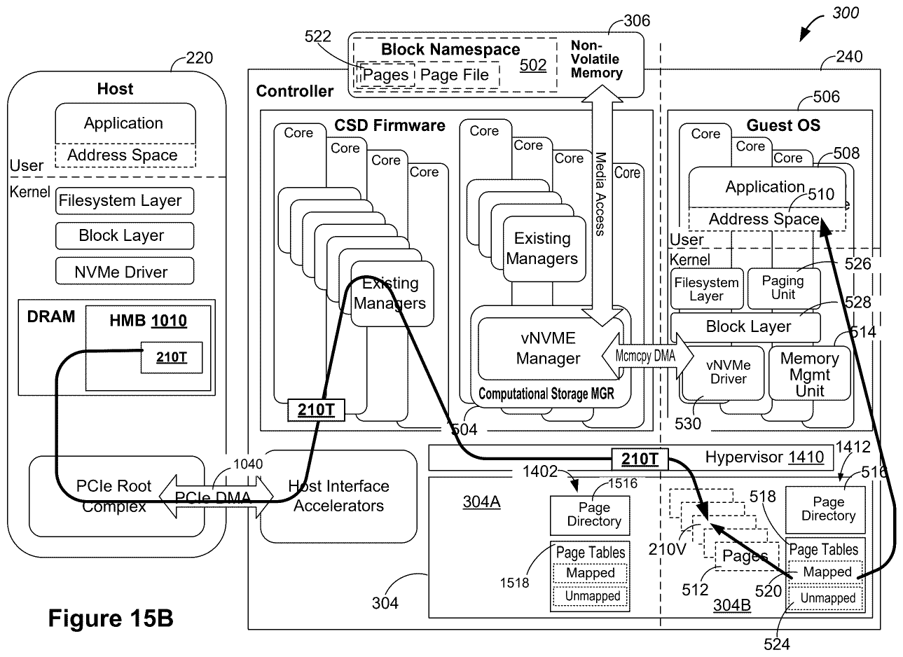

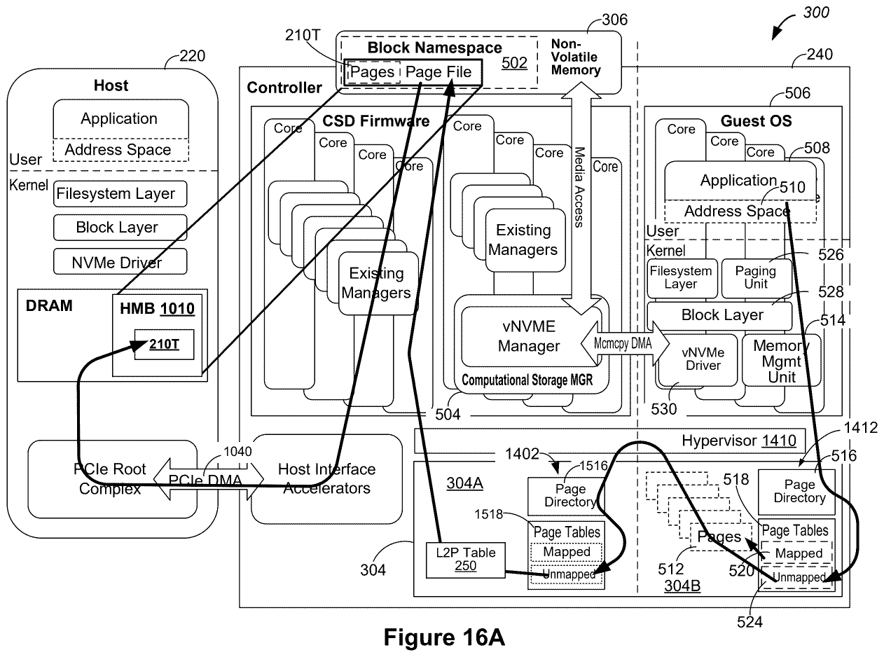

Further, in some embodiments, when the hypervisor 1410 is executed, a plurality of address translation stages are executed, and include a first address translation stage and a second address translation stage. The first address translation stage is implemented based on a local paging structure 1412 of the second memory portion 304B. The first paging structure 1402 is searched during the second address translation stage, when the target page 210T is unmapped in the local paging structure 1412. In some embodiments, each of the first paging structure 1402 and the local paging structure 1412 includes a respective page directory and a plurality of respective page tables. The first paging structure 1402 is stored in the first memory portion 304A and maps the first pages 1404 stored in the first memory portion 304A, the HMB 1010, and the non-volatile memory 306. The local paging structure 1412 is stored in the second memory portion 304B and maps memory pages 512 (e.g., in FIGS. 15A and 15B) stored in the second memory portion 304B. In some embodiments, the first paging structure 1402 is modified and controlled by the hypervisor 1410. When the memory controller 202 or the data processor 312 intends to access or modify the first paging structure 1402, the hypervisor 1410 verifies that the memory controller 202 or the data processor 312 is permitted to access or modify the first paging structure 1402. In some embodiments, the local paging structure 1412 is also controlled by the hypervisor 1410. Alternatively, in some embodiments, the local paging structure 1412 is not controlled by the hypervisor 1410, and the data processor 312 may access and modify the local paging structure 1412 directly without an overhead of trapping into and out of the hypervisor 1410.

Additionally, in some embodiments, the target page 210T is determined to be stored the HMB 1010 of the host device 220 based on the first paging structure 1402. The hypervisor 1410 orchestrates a direct memory access of the target page stored in the HMB 1010 and stores the target page 210T in place of a victim page in the second memory portion 304B.

In some embodiments, the data processor 312 executes an application 508 in a memory operating system 506 (e.g., embedded Linux OS). The target page 210T has a target logical address 1420 in an application address space associated with the application 508, and the target logical address 1420 is mapped to a target physical address 1418 in the second memory portion 304B. The data request 1406 may include the target logical address of the target page 210T. In some embodiments, the data processor 312 determines that the target page 210T is not stored in the second memory portion 304B, and generates the data request 1406. In some embodiments, the target page 210T is stored in the second memory portion 304B of the volatile memory 304 for the data processor 312.

In some embodiments, the second memory portion 304A of the volatile memory 304 may further store a local paging structure 1412. After storing the target page, a target mapping entry is created in the local paging structure 1412 to map a target logical address 1420 of the target page 210T to a target physical address 1418 of the target page 210T in the second memory portion 304B of the volatile memory 304.

In some embodiments, a plurality of pages are cached in the second memory portion 304B for the data processor 312. A victim page 210V is identified in the plurality of pages stored in the second memory portion 304B of the volatile memory 304, and the target page 210T is stored in place of the victim page 210V. Further, in some embodiments, the victim page 210V is moved to the HMB 1010 (e.g., stored in the HMB 1010), before the target page 210T is stored in the second memory portion 304B. In some embodiments, the second memory portion 304B further stores a local paging structure 1412 including a victim mapping entry mapping a victim logical address of the victim page 210V to a victim physical address of the victim page 210V in the second memory portion 304B. The victim logical address of the victim page 210V is unmapped in the local paging structure 1412 from the victim physical address of the victim page 210V in the second memory portion, thereby allowing the target page 210T to be stored in the corresponding the physical address. In other words, the victim physical address of the victim page 210V is the target physical address 1418 of the target page 210T, and is cleared to store the target page 210T.

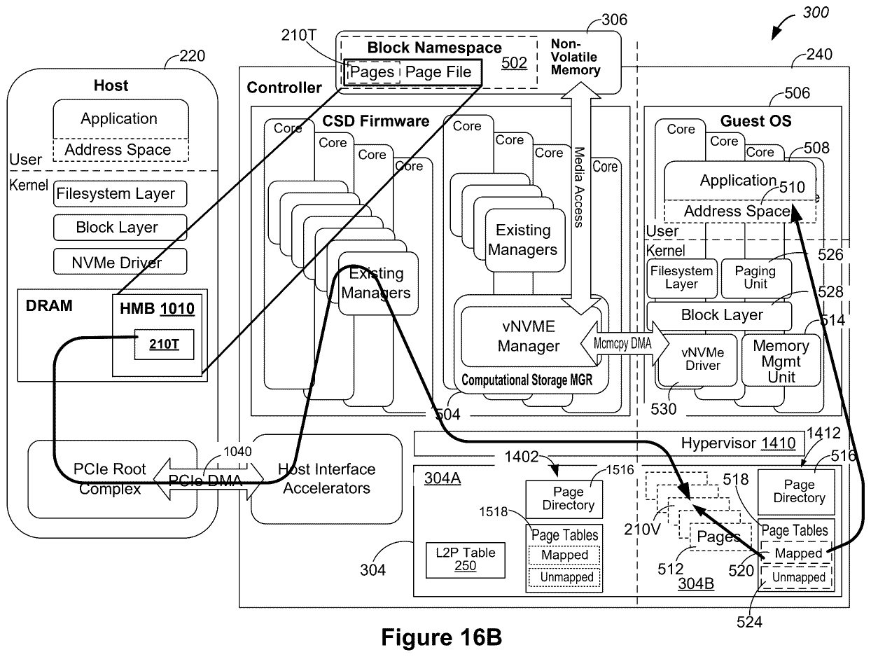

In some embodiments, the target location 1408 of the target page 210T stored in the first paging structure 1402 corresponds to a page file 1422 of the non-volatile memory 306. The target page 210T is copied from the page file 1422 of the non-volatile memory 306 to the HMB 1010, and then from the HMB 1010 to the second memory portion 304B. More details on using the HMB 1010 to move the target page 210T from the non-volatile memory 306 to the volatile memory 304 are explained below with reference to FIGS. 16A and 16B. Alternatively, in some embodiments, the target page 210T is copied from the page file 1422 of the non-volatile memory 306 to the second memory portion 304B without using the HMB 1010.

In some embodiments, the first memory portion 304A stores address mapping data temporarily for the memory controller 202 in addition to the first paging structure 1402. The address mapping data map a plurality of logical addresses of data stored in the non-volatile memory 306 to a plurality of physical addresses of the non-volatile memory 306.

In some embodiments, in accordance with a NVMe storage access and transport protocol, the memory device 240 (e.g., an SSD) implements an isolated namespace to manage paging for the data processor 312. The memory device 240 may extract mapped pages, and exit victim pages 210V for storing unmapped pages (e.g., target page 210T). Further, in some embodiments, the memory device 240 executes an embedded operating system 506 by the data processor. A memory access request (e.g., data request 1406) is issued for the target page 210T, and the memory access request is translated to the isolated namespace to generate a translated request for the target page 210T.

In some embodiments, the memory device 240 communicates a host read or write command that complies with a Transaction Level Protocol (TLP) via a PCIe bus 1040 coupled between the memory device 240 and the host device 220 including the HMB 1010. In some embodiments, the host read or write command includes a read request for fetching the target page 210T stored in the HMB 1010 of the host device 220. Alternatively, in some embodiments, the host read or write command includes a write request for writing the victim page 210V in the HMB 1010 of the host device 220.

FIGS. 15A and 15B are block diagrams of an example electronic system 300 that applies a hypervisor 1410 to provide supplemental memory resources to a data processor 312s, in accordance with some embodiments. The electronic system 300 includes a memory device 240 (e.g., an SSD) coupled to the host 220. The memory device 240 further includes a storage manager 504 and a Linux compute system 506. Volatile memory 304 (e.g., DRAM 228A, SRAM 224) is shared between memory storage functions and compute functions of the memory device 240. In some embodiments, the Linux compute system 506 executes an application 508 having an address space 510 on an application level. The address space 510 includes a plurality of address space mappings to associate virtual addresses of the application 508 to physical addresses of pages 512 stored in the volatile memory 304 (e.g., the DRAM buffer 228A). A memory management unit (MMU) 514 is applied in an operating system kernel to configure the address space mappings of the address space 510 associated with the page 512 stored in the DRAM buffer 228A. In some embodiments, the MMU 514 identifies a physical page 512 stored in the volatile memory 304 (e.g., the DRAM buffer 228A) in response to a request (e.g., a data request 1406) for an application page of the application 508 corresponding to a logical address. More specifically, the MMU 514 checks a page directory 516 to identify a page table 518 to identify the physical page 512 among a mapped portion 520 storing physical addresses of locally mapped pages (e.g., including a physical address of the page 512).

In some embodiments, the hypervisor 1410 is executed on the memory device 240 to manage the memory controller 202 and the data processor 312 as its tenants, e.g., by providing different memory resources (e.g., volatile memory 304, the HMB 1010 of the host device 220, the non-volatile memory 306) to the tenants. Further, in some embodiments, the volatile memory 304 includes a first memory portion 304A allocated to the memory controller 202 and a second memory portion 304B allocated to the data processor 312. The first memory portion 304A stores a first paging structure 1402 having a first page directory 1516 and a plurality of first page tables 1518. The first paging structure 1402 is managed by the hypervisor 1410, and the data processor 312 or the memory controller 202 may access the first paging structure 1402 by way of the hypervisor 1410 (e.g., when the access is approved by the hypervisor 1410). In some embodiments, the second memory portion 304B stores a local paging structure 1412 including a local page directory 516 and a plurality of local page tables 518, as well as a plurality of pages 512. The local paging structure 1412 is accessible to the data processor 312.

Referring to FIG. 15A, in some embodiments, the mapped portion 520 includes mapping entries corresponding to the plurality of pages 512 stored locally in the second memory portion 304B. The unmapped portion 520 corresponds to pages that are not stored locally in the second memory portion 304B. A first page fault happens when the local paging structure 1412 is checked and no physical page 512 stored in the second memory portion 304B, which is allocated to the data processor 312, is found for a logical address of a target page 210T requested by the application 508. After the first page fault, the hypervisor 1410 checks the first paging structure 1402 to identify the target page 210T stored in the first memory portion 304A, the HMB 1010 of the host device 220, or the non-volatile memory 306. More specifically, in some embodiments, the application 508 issues a request for the target page 210T, causing a page fault, because the target page 210T is not stored in the second memory portion 304B. Instead, the hypervisor 1410 determines that information of the target page 210T is stored in a mapped portion of the first page tables 1518 of the first paging structure 1402. The information of the target page 210T is extracted from the mapped portion of the first page tables 1518, and applied to identify the target page 210T in the first memory portion 304A or the HMB 1010 of the host device 220.

In some embodiments, after the hypervisor 1410 determines that the target page 210T is stored in the HMB 1010 of the host device 220 based on the mapped portion of the first page tables 1518, the hypervisor 1410 issues a host read command 1502 to the memory controller 202. The host read command is translated to a first request 1504 that is communicated to the host device 220 via a PCIe bus 1040.

Referring to FIG. 15B, in some embodiments, the target page 210T is copied from the HMB 1010 of the host device 220 into a victim cache location in the second memory portion 304B, e.g., by way of the hypervisor 1410, and mapped into the address space 510 associated with the application 508. A page fault handler returns, e.g., to identify information of the victim page 210V (e.g., a physical address of the victim cache location) in the mapped portion 520 in the page tables 518. The application 508 can freely access the pages (e.g., page 512) identified in the mapped portion 520. In some embodiments, before the target page 210T is copied into the victim cache location for the victim page 210V, the victim page 210V is copied to the HMB 1010, the block namespace 502 of the non-volatile memory 306, or the first memory portion 304A, while a location of the victim page 210 is added into the unmapped portion 524 of the page tables 518.

In some embodiments, firmware of the memory device uses HMB semantics to reserve a DRAM region (e.g., an HMB 1010) in a host device 220 to be used by the data processor 312 of the memory device 240. The data processor 312 of the memory device 240 may execute an embedded operating system 506 (e.g., Linux), and the HMB 1010 of the host device is exposed to the embedded operating system via one of a passthrough HMB memory semantic, an isolated namespace, and an VirtIO virtual machine interface. For example, the passthrough HMB memory semantic configures the HMB 1010 as a non-uniform memory access (NUMA) node or map the HMB 1010 directly into an address space. Accesses from the embedded operating system of the data processor are processed with two stages of translation (e.g., based on a TLP, by the hypervisor). For example, an access request is issued by the data processor 312, and translated into a TLP read or write request to access the HMB 1010 of the host device 220. Alternatively, in some embodiments, the hypervisor 1410 is configured with a plurality of address translation stages, which includes a first stage using the mapped portion 520 of the local page tables 518 and a second stage using the unmapped portion 524 of the local page tables 518.

FIGS. 16A and 16B are block diagrams of an example electronic system 300 that applies a hypervisor 1410 to fetch, for a data processor 312, data stored in a non-volatile memory 306 by way of an HMB 1010, in accordance with some embodiments. In some embodiments, the first paging structure 1402 is coupled to, or includes, an L2P address indirection table 250 that stores physical addresses for a set of logical addresses, e.g., a logical block address (LBA). The L2P address indirection table 250 is used by the memory controller 202 to translate logical data addresses into physical block addresses of the non-volatile memory 306. In some embodiments, the L2P address indirection table 250 may be part of the mapped portion of the page tables 1518, and a physical address of the target page 210T stored in the non-volatile memory 306 may be identified in the mapped portion of the page tables 1518 based on a logical address of the target page 210T. Conversely, in some embodiments, the L2P address indirection table 250 may be distinct from the first paging structure 1402. When the logical address of the target page 210T is identified in the unmapped portion of the first page tables 1518, the L2P address indirection table 250 may be checked to determine the physical address of the target page 210T within the non-volatile memory 306.

Referring to FIG. 16A, in some embodiments, the target page 210T is copied to the HMB 1010 of the host device 220, e.g., via the PCIe bus 140, and the mapped portion of the first page tables 518 of the first paging structure is updated to include a mapping entry associating the logical address of the target page 210T with a physical address of the target page 210T in the HMB 1010. Alternatively, in some embodiments not shown, the target page 210T is copied to the first memory portion 304A in place of a victim page, and the mapped portion of the first page tables 518 of the first paging structure 1402 is updated to include a mapping entry associating the logical address of the target page 210T with a physical address of the target page 210T in the first memory portion 304A. Alternatively, in some embodiments not shown, the target page 210T is copied to the second memory portion 304B in place of a victim page, without being copied to the HMB 1010. The mapped portion 520 of the local page tables 518 of the local paging structure 1412 is updated to include a mapping entry associating the logical address of the target page 210T with a physical address of the target page 210T in the second memory portion 304B. Additionally, in some embodiments, the target page 210T is included in a page file, which may include one or more additional pages distinct from the target page 210T, and the page file is copied to the HMB 1010, the first memory portion 304A, or the second memory portion 304B.

Referring to FIG. 16B, in some embodiments, after the target page 210T is stored in the HMB 1010, the target page 210T is copied to the second memory portion 304B in place of a victim page, and the mapped portion 520 of the local page tables 518 of the local paging structure 1412 is updated to include a mapping entry associating the logical address of the target page 210T with a physical address of the target page 210T in the second memory portion 304B. More specifically, in some embodiments, the target page 210T is transferred via the PCIe bus 1040 and managed by the memory controller 202 and the hypervisor 1410 for storage in the second memory portion 304B. The application 508 may access the second memory portion 304B to extract the target page 210T for further processing (e.g., a write or read operation of the application 508).

In some embodiments, the application 508 executed by the data processor 312 of the memory device 240 accesses unmapped pages via the hypervisor 1410, which translates a logical address of the target page 210T to a page in a page file of the block namespace 502 of the non-volatile memory. The page file of the block namespace 502 including the target page 210T is aliased to the HMB 1010 of the host device 220. A corresponding LBA space identity (e.g., the logical address) may be mapped to a physical address in the HMB 1010 as well as to a physical address in the block namespace 502, allowing the HMB 1010 of the host device 220 to be exposed to the embedded operating system 506 of the memory device 240. In some embodiments, the hypervisor 1410 is configured with a plurality of address translation stages, which may include a first stage using the mapped portion 520 of the local page tables 518 and a second stage using the unmapped portion 524 of the local page tables 518. The hypervisor 1410 orchestrates a direct memory access to extract the target page 210 from the HMB 1010, and replaces a victim page 210V in the second memory portion 304B via the plurality of address translation stages. After being stored and mapped in the second memory portion 304B, the target page 210 may be used in a write or read operation for the application 508.

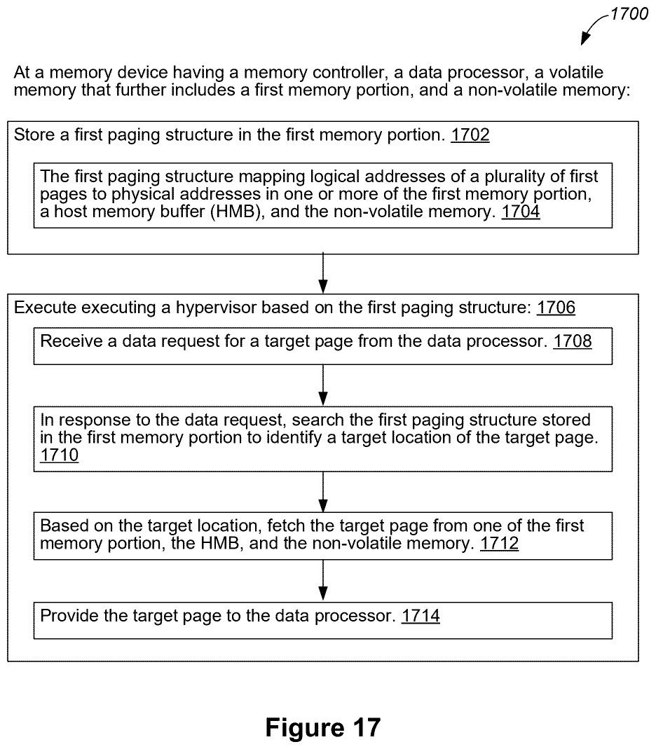

FIG. 17 is a flow diagram of an example method 1700 for managing volatile memory space in a memory device 240, in accordance with some embodiments. The method 1700 is implemented by a memory device 240 having a memory controller 202, a data processor 312, a volatile memory 304 that further includes a first memory portion 304A, and a non-volatile memory 306. In some embodiments, the memory device 240 includes a plurality of processor cores 602 configured to provide the memory controller 202 and the data processor 312. For example, the memory device 240 allocates a first subset of processor cores 602A (FIG. 14) to perform a plurality of memory access and management functions of the memory controller 202, and allocates a second subset of processor cores 602B (FIG. 14) to perform a plurality of in-memory data processing functions of the data processor 312. In some embodiments, the volatile memory 304 is partitioned to the first memory portion 304A for storing address mapping data (e.g., an L2P address indirection table 250 in FIGS. 16A and 16B) temporarily for the memory controller 202 and a second memory portion 304B (FIG. 14) for storing payload data (e.g., pages 512) temporarily for the data processor 312.

In some embodiments, the memory device 240 stores (operation 1702) a first paging structure 1402 in the first memory portion 304A. The first paging structure 1402 maps (operation 1704) logical addresses of a plurality of first pages 1404 (e.g., first pages 1404A, 1404B, and 1404C) to physical addresses in one or more of the first memory portion 304A, a host memory buffer (HMB) 1010, and the non-volatile memory 306. The memory device 240 executes (operation 1706) a hypervisor 1410 based on the first paging structure 1402. A data request 1406 for a target page 210T is received (operation 1708) from the data processor 312. In response to the data request 1406, the memory device 240 (e.g., the hypervisor 1410) searches (operation 1710) the first paging structure 1402 stored in the first memory portion 304A to identify a target location 1408 of the target page 210T. Based on the target location 1408, the target page 210T is fetched (operation 1712) from one of the first memory portion 304A, the HMB 1010, and the non-volatile memory 306, and provided (operation 1714) to the data processor 312, e.g., for further processing. In some embodiments, the target page 210T is stored in the second memory portion 304B before being provided to the data processor 312 for further processing.

Some implementations of this application are directed to multi-tenant volatile memory sharing in a memory system. Various examples of these aspects of the disclosure are described as numbered clauses (1, 2, 3, etc.) for convenience. These are provided as examples, and do not limit the subject technology.
Clause 1. A method for managing memory resources, comprising: at a memory device having a memory controller, a data processor, a volatile memory that further includes a first memory portion, and a non-volatile memory; storing a first paging structure in the first memory portion, the first paging structure mapping logical addresses of a plurality of first pages to physical addresses in one or more of the first memory portion, a host memory buffer (HMB), and the non-volatile memory; and executing a hypervisor based on the first paging structure, including: receiving a data request for a target page from the data processor; in response to the data request, searching the first paging structure stored in the first memory portion to identify a target location of the target page; based on the target location, fetching the target page from one of the first memory portion, the HMB, and the non-volatile memory; and providing the target page to the data processor.
Clause 2. The method of clause 1, wherein the memory device is coupled to a host device including a dynamic random-access memory (DRAM), and the DRAM is configured to provide the HMB using passthrough HMB memory semantics.
Clause 3. The method of clause 1 or 2, further comprising: configuring, by the hypervisor, the first memory portion, the HMB, and the non-volatile memory to a plurality of paravirtualized memory devices.
Clause 4. The method of any of clauses 1-3, wherein the volatile memory includes a second memory portion distinct from the first memory portion, and the method further comprises allocating the second memory portion to the data processor.
Clause 5. The method of clause 4, executing the hypervisor further comprising implementing a plurality of address translation stages including a first address translation stage and a second address translation stage, wherein: the first address translation stage is implemented based on a local paging structure of the second memory portion; and the first paging structure is searched during the second address translation stage, when the target page is unmapped in the local paging structure.
Clause 6. The method of clause 4 or 5, further comprising orchestrating, by the hypervisor, a direct memory access of the target page stored in the HMB and storing the target page in place of a victim page in the second memory portion.
Clause 7. The method of any of clauses 4-6, further comprising, by the data processor: executing an application in a memory operating system, wherein the target page has a target logical address in an application address space associated with the application, and the target logical address is mapped to a target physical address in the second memory portion.
Clause 8. The method of any of clauses 4-7, further comprising: determining, by the data processor, that the target page is not stored in the second memory portion; and generating the data request by the data processor.
Clause 9. The method of any of clauses 4-8, further comprising storing the target page in the second memory portion of the volatile memory for the data processor.
Clause 10. The method of clause 9, wherein the second memory portion of the volatile memory further stores a local paging structure, and the method further comprises: after storing the target page, creating a target mapping entry in the local paging structure, the target mapping entry mapping a target logical address of the target page to a target physical address of the target page in the second memory portion of the volatile memory.
Clause 11. The method of any of clauses 4-10, further comprising: caching a plurality of pages in the second memory portion for the data processor; and identifying a victim page in the plurality of pages stored in the second memory portion of the volatile memory; and storing the target page in place of the victim page.
Clause 12. The method of clause 11, further comprising storing the victim page in the HMB.
Clause 13. The method of clause 11 or 12, wherein the second memory portion further stores a local paging structure including a victim mapping entry mapping a victim logical address of the victim page to a victim physical address of the victim page in the second memory portion, the method further comprising: unmapping, in the local paging structure, the victim logical address of the victim page to the victim physical address of the victim page in the second memory portion.
Clause 14. The method of any of clauses 4-13, further comprising caching a plurality of pages in the second memory portion for the data processor.
Clause 15. The method of any of clauses 1-14, wherein the target location of the target page corresponds to a page file of the non-volatile memory, and fetching the target page from the target location further comprises: enabling copying the target page from the page file of the non-volatile memory to the HMB; and obtaining the target page from the HMB.
Clause 16. The method of any of clauses 1-15, wherein the first memory portion stores address mapping data (e.g., the L2P address indirection table 250) of the non-volatile memory temporarily for the memory controller in addition to the first paging structure.
Clause 17. The method of any of clauses 1-15, wherein the first paging structure includes address mapping data (e.g., L2P address indirection table 250) of the non-volatile memory.
Clause 18. The method of any of clauses 1-17, further comprising: in accordance with a NVMe storage access and transport protocol, implementing an isolated namespace to manage paging for the data processor.
Clause 19. The method of clause 18, further comprising: executing an embedded operating system by the data processor, including issuing a memory access request for the target page; and translating the memory access request to the isolated namespace to generate a translated request for the target page.
Clause 20. The method of any of clauses 1-19, further comprising: communicating a host read or write command that complies with a Transaction Level Protocol (TLP) via a PCIe bus coupled between the memory device and a host device including the HMB.
Clause 21. A memory device, comprising: a plurality of processor cores configured to provide a memory controller and a data processor; a volatile memory; and a non-volatile memory; wherein the memory device stores one or more programs comprising instructions for performing a method in any of clauses 1-20.
Clause 22. A non-transitory computer readable storage medium storing one or more programs, the one or more programs comprising instructions that, when executed by a memory device having a memory controller, a data processor, a volatile memory, and a non-volatile memory, cause the memory device to perform a method in any of clauses 1-20.

### Dynamic Volatile Memory Usage for In-Memory Data Processing

Some implementations of this application are directed to dynamically managing volatile memory usage for data processing operations implemented by a memory device 240 (e.g., an SSD). In some embodiments, the memory device is configured to act as a computational storage device (CSD), and includes a memory controller performing memory access and management functions and a data processor performing a plurality of in-memory data processing functions. Volatile memory of the memory device may be partitioned to a first memory portion for storing at least address mapping data temporarily for the memory controller and a second memory portion for storing data temporarily for the data processor. The second memory portion stores a plurality of memory pages including a set of hot pages and a set of cold pages, and the set of hot pages is more frequently used by the data processor than the set of cold pages. Memory space corresponding to the set of cold pages may be temporarily loaned to the memory controller. Stated another way, the memory space that is infrequently accessed by the data processor may be temporarily loaned to the memory controller and returned, when the data processor demands it.

In some embodiments, the data processor executes an embedded operating system (e.g., Linux OS) including a balloon driver. The balloon driver is configured to cause the cold pages stored in the second memory portion allocated to the data processor to page out. In some embodiments, memory space storing the cold pages are handed to a firmware side, facilitating FTL table storage or associated memory access and management functions. When reused on an embedded operating system side, contents may be paged out to a dedicated region of the non-volatile memory of the memory device. It is noted that an FTL is an intermediate system consisting of software and hardware that manages operations on the memory device 240. The FTL performs tasks such as address translation, garbage collection, wear-leveling, error correction, and bad block management. In some embodiments, the FTL table maps logical addresses from a file system to physical addresses of memory pages stored in the non-volatile memory 306.

Stated another way, in some embodiments, non-uniform memory access (NUMA) is implemented to create paravirtualized memory devices (e.g., the first memory portion and the second memory portion of the volatile memory), which are accessible to separate processing nodes (e.g., the memory controller 202, the data processor 312). NUMA tiering may be applied to the DRAM buffer 228A of the volatile memory 304. More specifically, in some embodiments, the cold pages are swapped out of the second memory portion and stored in a remote node (e.g., in the non-volatile memory). The corresponding memory space is reclaimed internally, added into the first memory portion, and used by the firmware of the memory controller to implement memory access and management functions. Further, in some embodiments, the memory space may be swapped back into the second memory portion, and reclaimed back from the memory controller by the data processor for use in storing memory pages processed by the data processor. Information stored in the memory space for the memory controller may be stored in the non-volatile memory, before the memory space is reclaimed by the data processor to store the memory pages processed by the data processor.

Some implementations are directed to a computational storage device including the firmware and the embedded operating system, which may exist in a cache coherent shared memory architecture and exchange data at a fast data rate (e.g., via an L3 cache load/store access). Both the firmware and the embedded operating system have or implement storage subsystems, and understand NVMe semantics, including HMB. Both the firmware and the embedded operating system leverage transient hot plugged memory. For example, the firmware and the embedded operating system of the memory system may be coupled via a PCIe bus to host DRAM resources (e.g., HMB), and reserves a dedicated portion of the HMB. As such, characteristics of an electronic system can be used to improve overall performance of the electronic system, particularly when the electronic system has limited dynamic memory resources without relying on expanding a size of the volatile memory or adopting a complicated memory structure.

In some embodiments, memory resources allocated to an embedded operating system are increased by paging to the non-volatile memory through fast cut through internal pathway. In some embodiments, memory resources allocated to an embedded operating system are increased by dynamically sharing internal or external memory using known protocols and memory management unit (MMU). In some embodiments, subsystems and methods are leveraged to identify cold memory locations for tiering to slow memory.

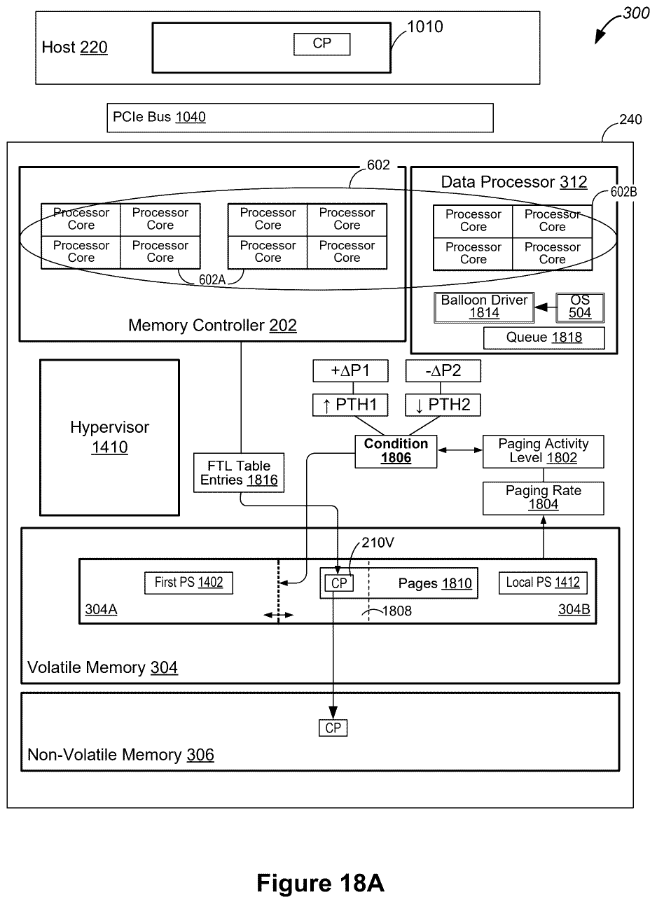

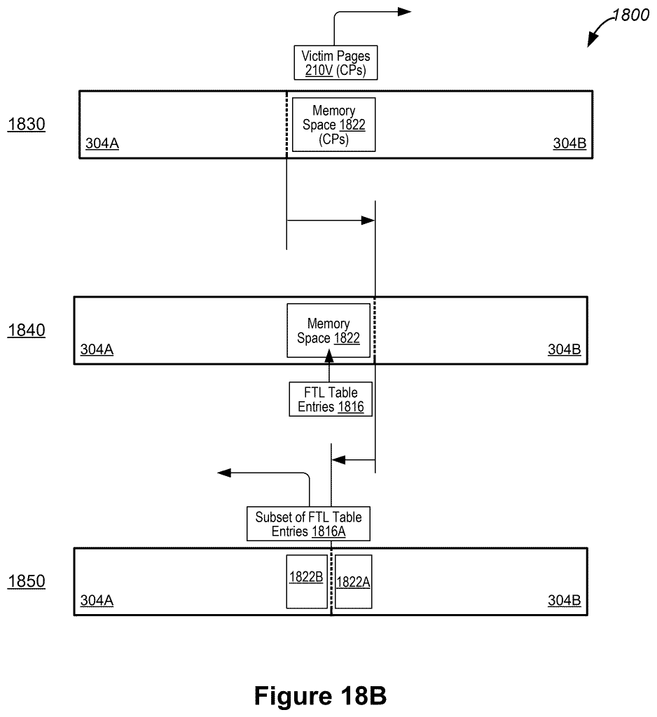

FIG. 18A is a block diagram of an example electronic system 300 that dynamically applies volatile memory 304 in a memory device 240, in accordance with some embodiments, and FIG. 18B illustrates an example process 1800 of releasing and reclaiming part of volatile memory 304 by a data processor 312, in accordance with some embodiments. The memory device 240 includes a memory controller 202, a data processor 312, a volatile memory 304, and a non-volatile memory 306. In some embodiments, an embedded operating system 506 (e.g., Linux OS) is executed by the data processor 312 to perform the in-memory data processing functions. The non-volatile memory 306 (e.g., NAND flash memory cells) is configured to store data independently of whether the electronic system 300 is decoupled from a power source. The volatile memory 304 further includes an SRAM buffer 224, a DRAM buffer 228A, or both, and is configured to store data (e.g., those processed by the data processor 312) temporarily. The volatile memory 304 is partitioned to a first memory portion 304A for storing at least address mapping data 604 temporarily for the memory controller 202 and a second memory portion 304B for storing data temporarily for the data processor 312.

In some embodiments, the memory device 240 caches, in the second memory portion 304B, a plurality of pages 1810 to be used by the data processor 312. The memory device 240 monitors a paging activity level 1802 at the second memory portion 304B, and the paging activity level 1802 corresponds to at least a paging rate 1804 for fetching pages 210 from one or more memory resources (e.g., non-volatile memory 306) distinct from the second memory portion 304B. In accordance with a determination that the paging activity level 1802 satisfies a condition 1806, the memory device 240 adjusts a current size of the second memory portion 304B allocated to the data processor 312. In some situations, at a booting stage (e.g., a startup) of the memory device 240, each of the first memory portion 304A and the second memory portion 304B has a respective predefined memory size.

In some embodiments, the data processor 312 releases a subset 1808 of the second memory portion 304B. In an example, the subset 1808 of the second memory portion 304B stores one or more cold pages CPs, and a balloon driver 1814 of the data processor 312 releases memory space of the cold pages CPs to a hypervisor 1410. Each of the pages 1810 stored in second memory portion 304B may become a cold page CP when a frequency of accessing the respective page 1810 by the data processor 312 falls below a cold page access threshold. In some embodiments, when the memory space of a cold page CP is released, the cold page CP is stored in the non-volatile memory 306 by the hypervisor 1410 and the memory controller 202. After the subset 1808 of the second memory portion 304B is released to the hypervisor 1410, the released subset 1808 of the second memory portion 304B is allocated to the memory controller 202 by the hypervisor 1410, and becomes part of the first memory portion 304A for implementing input/output (I/O) path buffering of the memory device 240. After the subset 1808 of the second memory portion 304B is released, e.g., to be used by the memory controller 202, the current size of the second memory portion 304B allocated to the data processor 312 is increased (e.g., reclaimed) by at least partially recovering the subset 1808 of the second memory portion 304B.

In some embodiments, in accordance with the condition 1806, when the paging activity level 1802 increases to or above a first paging threshold PTH1, the memory device 240 (e.g., the hypervisor 1410) increases the current size of the second memory portion 304B by a first predefined portion AP1. Further, in some embodiments, in accordance with the condition, when the paging activity level 1802 drops to or below a second paging threshold PTH2, the memory device 240 (e.g., the hypervisor 1410) reduces the current size of the second memory portion 304B by a second predefined portion AP2. Additionally, in some embodiments, the first paging threshold AP1 is greater than the second paging threshold AP2. Alternatively and additionally, in some embodiments, the second paging threshold AP2 is greater than the first paging threshold AP1. Alternatively, the first paging threshold AP1 is equal to the second paging threshold AP2.

In some embodiments, the paging rate 1804 is measured by a number of pages fetched from the one or more memory resources during a predefined duration of time. Alternatively, in some embodiments, the paging rate 1804 is measured by a number of pages victimized from the second memory portion 304B during a predefined duration of time. Each victim page 210V (e.g., a cold page CP) may be stored in the first memory portion 304A, the HMB 1010 of the host device 220, or the non-volatile memory 306. In some embodiments, the paging activity level 1802 is based on a variation of the paging rate 1804 during a predefined duration of time.

In some embodiments, the paging activity level 1802 further corresponds to a page access queue 1818 including a plurality of data requests to be fulfilled via the second memory portion 304B. Further, in some embodiments, the paging activity level 1802 is a weighted combination of the paging rate 1804 of the second memory portion 304B and a length of the page access queue 1818.

Referring to FIG. 18B, in some embodiments, the data processor 312 executes an operating system 506 including a balloon driver 1814, and stores a plurality of pages 1810. The plurality of pages 1810 include (operation 1830) a plurality of cold pages CPs in a memory space 1822. The ballon drivers 1814 loans (operation 1840) memory space 1822 of a plurality of cold pages CPs to the memory controller 240, e.g., via a hypervisor 1410. The current size of the second memory portion 304B is adjusted (operation 1850) by reclaiming memory space 1822A of one or more cold pages CPs of the plurality of cold pages CPs by the ballon driver 1814 of the data processor 312. Further, in some embodiments, when the memory space 1822 of the plurality of cold pages CPs is loaned (operation 1840) to the memory controller 240, a set of flash translation layer (FTL) table entries 1816 is stored in the memory space 1822 of the plurality of cold pages CPs. Additionally, in some embodiments, after the memory space 1822 of the plurality of cold pages CPs is released (operation 1840) to the memory controller 202, the memory space 1822 is used as a temporary transfer buffer associated with a memory access operation implemented (e.g., by the memory controller 202) in response to a host memory access request. A subset of FTL table entries 1816A stored in the memory space of the one or more cold pages CPs is subsequently moved to the non-volatile memory 306, before the memory space 1822A of the one or more cold pages is reclaimed (operation 1850) by the ballon driver 1814. In some embodiments, memory space 1822B may still be released to, and used by, (operation 1850) the memory controller 202, after the memory space 1824A is recovered by the data processor 312.

In some embodiments, the first memory portion 304A stores a first paging structure (PS) 1402 for accessing pages stored in one or more of a host memory buffer (HMB) 1010, a host-side dynamic random-access memory (DRAM), a hot plugged memory, and the non-volatile memory 306. In some embodiments, the second memory portion 304B stores a local paging structure (PS) 1412 for accessing the plurality of pages 1810 stored locally in the second memory portion 304B. More details on accessing memory resources supplemental to the second memory portion 304B, which is allocated to the data processor 312, based on the paging structures 1402 and 1412 are discussed above with reference to FIGS. 14-17.

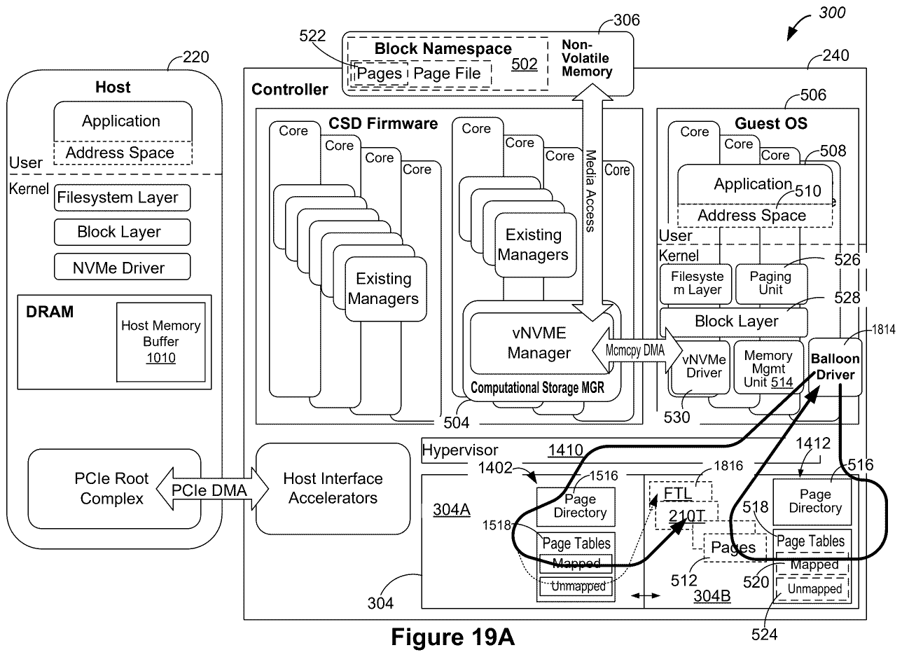

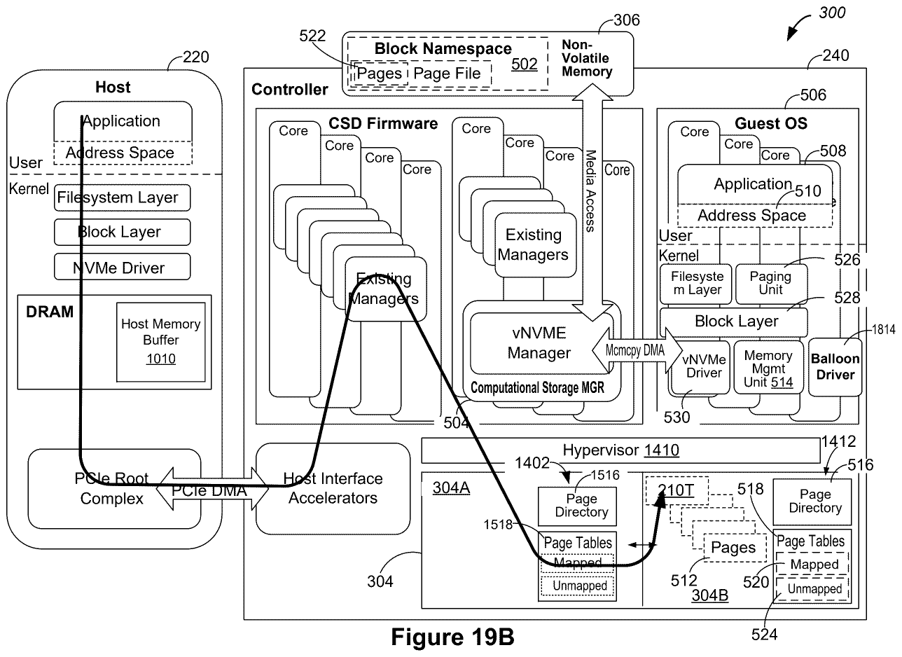

FIGS. 19A and 19B are block diagrams of an example electronic system 300 that dynamically manages memory space of volatile memory 304 in a memory device 240, in accordance with some embodiments. The electronic system 300 includes a memory device 240 (e.g., an SSD) coupled to the host 220. The memory device 240 (also called a CSD) further includes a storage manager 504 implemented by a memory controller 202 and a Linux compute system 506 implemented by a data processor 312. Volatile memory 304 (e.g., DRAM 228A, SRAM 224) is shared between memory storage functions and compute functions of the memory device 240. In some embodiments, a hypervisor 1410 is executed on the memory device 240 to manage the memory controller 202 and the data processor 312 as its tenants, e.g., by providing different memory resources (e.g., volatile memory 304, the HMB 1010 of the host device 220, the non-volatile memory 306) to the tenants. Further, in some embodiments, the volatile memory 304 includes a first memory portion 304A allocated to the memory controller 202 and a second memory portion 304B allocated to the data processor 312. The first memory portion 304A stores a first paging structure 1402 having a first page directory 1516 and a plurality of first page tables 1518. The first paging structure 1402 is managed by the hypervisor 1410, and the data processor 312 or the memory controller 202 may access the first paging structure 1402 by way of the hypervisor 1410 (e.g., when the access is approved by the hypervisor 1410). In some embodiments, the second memory portion 304B stores a local paging structure 1412 including a local page directory 516 and a plurality of local page tables 518, as well as a plurality of pages 512. The local paging structure 1412 is accessible to the data processor 312.

Referring to FIG. 19A, in some embodiments, the mapped portion 520 includes mapping entries corresponding to the plurality of pages 512 stored locally in the second memory portion 304B. The unmapped portion 520 corresponds to pages that are not stored locally in the second memory portion 304B. A page fault happens when the local paging structure 1412 is checked and no physical page 512 stored in the second memory portion 304B, which is allocated to the data processor 312, is found for a logical address of a target page 210T requested by the application 508. After the first page fault, the hypervisor 1410 checks the first paging structure 1402 to identify the target page 210T stored in the first memory portion 304A, the HMB 1010 of the host device 220, or the non-volatile memory 306. More specifically, in some embodiments, the application 508 issues a request for the target page 210T, causing a page fault, because the target page 210T is not stored in the second memory portion 304B.

In some embodiments, the hypervisor 1410 may determine that information of the target page 210T is stored in a mapped portion of the first page tables 1518 of the first paging structure 1402. The information of the target page 210T is extracted from the mapped portion of the first page tables 1518, and applied to identify the target page 210T in the first memory portion 304A or the HMB 1010 of the host device 220. Alternatively, the hypervisor 1410 may identify information of the target page 210T in the unmapped portion of the page tables 1518, and determine that the target page 210T is stored in the non-volatile memory 306. The first memory portion 304A, the non-volatile memory 306, or both of them store an FTL table identifying a physical address of the target page 210T within the non-volatile memory 306.

In some embodiments, the second memory portion 304B stores a plurality of pages 512. Each of the pages 512 stored in second memory portion 304B may become a cold page CP when a frequency of accessing the respective page 512 by the data processor 312 falls below a cold page access threshold. Memory space corresponding to one or more cold pages CPs may be loaned to the firmware of the memory controller 202 by the balloon driver 1814. More specifically, the balloon driver 1814 causes the one or more cold pages CPs to page out, e.g., by storing the one or more cold pages CPs in the non-volatile memory 306 by way of the hypervisor 1410 and the memory controller 202. The memory space of the one or more cold pages CPs are made available and handed back to the firmware of the memory controller 202 for an FTL table storage associated with the non-volatile memory 306 or other use cases (e.g., associated with the HMB 1010 or the first memory portion 304A). Further, in some embodiments, when a paging activity of the data processor 312 satisfies a condition (e.g., increases beyond a corresponding threshold), the memory space of the one or more cold pages CPs may be taken back by the balloon driver 1814 of the data processor 312 to facilitate data processing by the data processor 312. In some embodiments, prior to being reused by the data processors, contents stored by the memory controller 202 may be paged out to a dedicated region of the non-volatile memory 306.

In some situations, the balloon driver 1814 allocates the memory space of a plurality of cold pages to the firmware of the memory controller 202, and the plurality of cold pages have a number of pages that is relatively large (e.g., greater than a page threshold) and creates a dynamic memory pressure on the data processor. The balloon driver 1814 releases the memory space corresponding to the plurality of cold pages stored in the second memory portion 304B to the hypervisor 1410, and the memory space may be used to map the first page tables 1518 of the first paging structure 1402. Stated another way, in an example, the page tables 1518 may include a mapping entry mapping a logical address to a physical address of a target page 210T that is stored in the second memory portion 304B, and the target page 210T may be accessed by the memory controller 202, e.g., to be provided to the host device 220 in response a host read request. Alternatively, in some embodiments, an FTL table entry 1816 (e.g., a subset of the FTL table) is stored in the second memory portion 304B for mapping the logical address of a target page 210T to a physical address in the non-volatile memory 306.

Referring to FIG. 19B, in some embodiments, the balloon driver 1814 is executed by an embedded operating system 506 of the data processor 312, and releases one or more cold pages CPs stored in the second memory portion 304B to be used by the memory controller 202. The memory space released from the cold page(s) is used as a transfer buffer. For example, the host device 220 executes an application requesting a target data 210T from the memory device 240. The memory controller 202 extracts the memory device 240 from the non-volatile memory 306 and stores the target page 210T in place of one of the released cold page(s), e.g., via the hypervisor 1410. The first paging structure 1402 is updated with a mapping entry in the mapped portion of the page tables 1518, identifying a physical address of the target page 210T corresponding to that of the cold page(s) stored in the second memory portion 304B. The memory controller 202 collaborates with the hypervisor 1410 to extract the target page 210T from the transfer buffer corresponding to the released cold page(s) and provided to the host device 220.

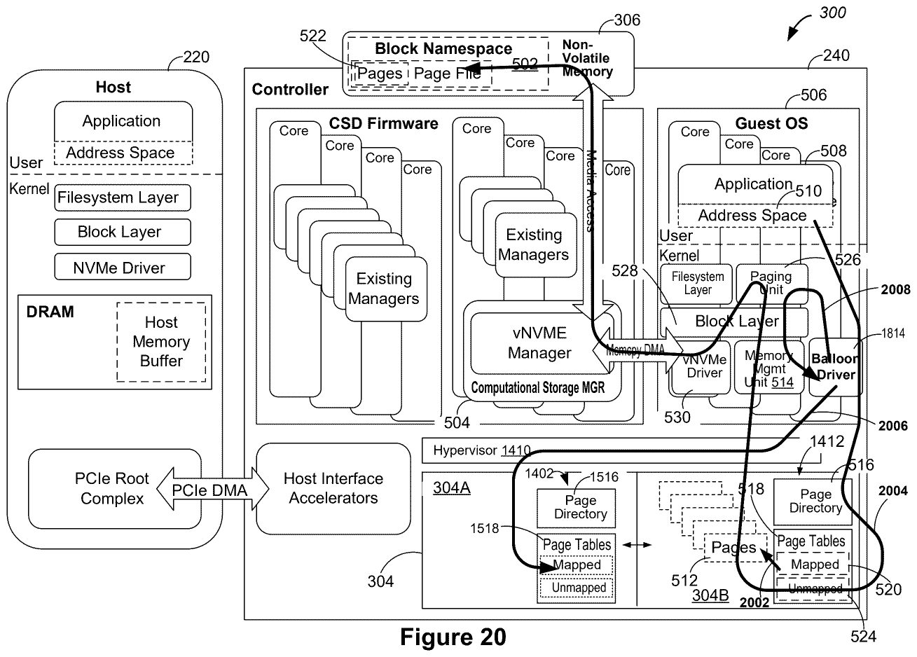

FIG. 20 is a block diagrams of an example electronic system 300 that dynamically manages memory space of volatile memory 304 in a memory device 240, in accordance with some embodiments. The volatile memory 304 includes a first memory portion 304A allocated to a memory controller 202 and a second memory portion 304B allocated to a data processor 312. The data processor 312 executes an embedded operating system 506 that includes a balloon driver 1814. In some embodiments, the mapped portion 520 includes mapping entries corresponding to the plurality of pages 512 stored (operation 2002) locally in the second memory portion 304B. In some embodiments, the unmapped portion 520 corresponds to pages that are not stored locally in the second memory portion 304B, and the data processor 312 accesses (operation 2004) the non-volatile memory 306 by way of the memory controller 202 to obtain the pages that are not mapped in the local paging structure 1412. Alternatively, in some embodiments, the data processor 312 collaborates with the hypervisor 1410 to access (operation 2006) pages that are stored in the first memory portion 304A, the HMB 1010, or the non-volatile memory.

In some embodiments, the second memory portion 304B stores a plurality of pages 512 used by the data processor 312. Each of the pages 512 may become a cold page CP when a frequency of accessing the respective page 512 by the data processor 312 falls below a cold page access threshold. The balloon driver 1814 may loan memory space corresponding to one or more cold pages CPs to the firmware of the memory controller 202. Before loaning the memory space, the balloon driver 1814 causes the one or more cold pages CPs to page out, e.g., by storing the one or more cold pages CPs in the non-volatile memory 306 by way of the hypervisor 1410 and the memory controller 202. The memory space of the one or more cold pages CPs are made available and handed to the firmware of the memory controller 202 for an FTL table storage associated with the non-volatile memory 306 or other use cases (e.g., associated with the HMB 1010 or the first memory portion 304A). Further, in some embodiments, when a paging activity of the data processor 312 satisfies a condition (e.g., increases beyond a corresponding threshold), the memory space of the one or more cold pages CPs may be taken back by the balloon driver 1814 of the data processor 312 to facilitate data processing by the data processor 312. In some embodiments, prior to being reused by the data processors, contents stored by the memory controller 202 may be paged out to a dedicated region of the non-volatile memory 306.

In some embodiments, the balloon driver 1814 tracks (operation 2008) a paging activity level 1802, e.g., by monitoring application page faults and page-in/out transfers of a paging unit 526 implemented by the data processor 312. In some situations, application page in/out activities show a spike, and the balloon driver 1814 reclaims the memory space of the cold pages CPs loaned to the firmware of the memory controller (also called the CSD firmware). The hypervisor 1410 unmaps these pages from a firmware address space and remaps them back into an address space associated with the data processor 312.

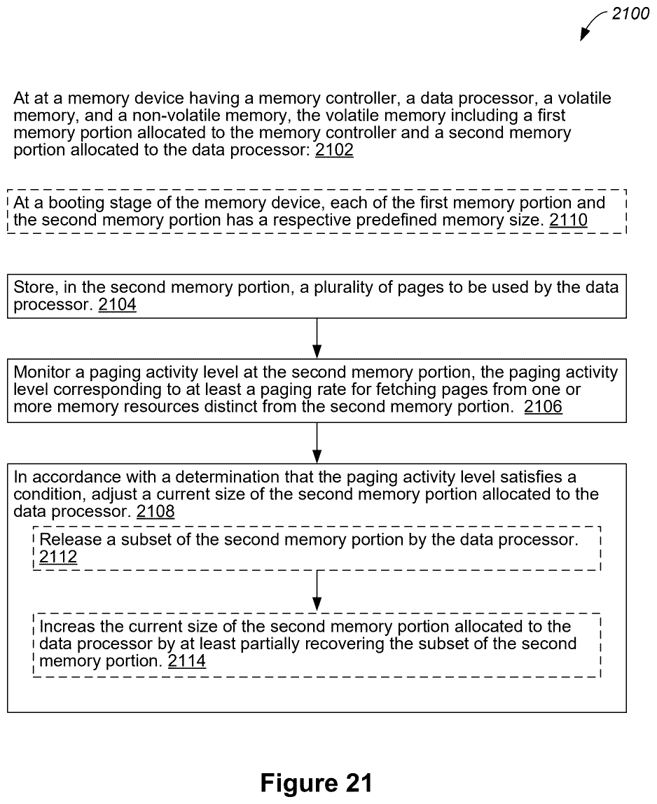

FIG. 21 is a flow diagram of an example method 2100 for managing volatile memory space in a memory device 240, in accordance with some embodiments. The method 2100 is implemented (operation 2102) by a memory device 240 having a memory controller 202, a data processor 312, a volatile memory 304, and a non-volatile memory 306. In some embodiments, the memory device 240 includes a plurality of processor cores 602 configured to provide the memory controller 202 and the data processor 312. For example, the memory device 240 allocates a first subset of processor cores 602A (FIG. 18A) to perform a plurality of memory access and management functions of the memory controller 202, and allocates a second subset of processor cores 602B (FIG. 18A) to perform a plurality of in-memory data processing functions of the data processor 312. In some embodiments, the volatile memory 304 is partitioned to the first memory portion 304A for storing address mapping data (e.g., an L2P address indirection table 250 in FIG. 2) temporarily for the memory controller 202 and a second memory portion 304B for storing data (e.g., pages 512) temporarily for the data processor 312.

In some embodiments, the memory device 240 stores (operation 2104), in the second memory portion, a plurality of pages 1810 (e.g., pages 512 in FIGS. 19A, 19B, and 20) to be used by the data processor 312. A paging activity level 1802 is monitored (operation 2106) at the second memory portion 304B, and corresponds to at least a paging rate 1804 for fetching pages from one or more memory resources distinct from the second memory portion 304B. In accordance with a determination that the paging activity level 1802 satisfies a condition, the memory device 240 adjusts (operation 2108) a current size of the second memory portion 304B allocated to the data processor 312 (e.g., by allocating a memory space of one or more cold pages to the memory controller 202).

In some embodiments, at a booting stage of the memory device 240, each of the first memory portion 304A and the second memory portion 304B has (operation 2110) a respective predefined memory size. In some embodiments, the data processor 312 releases (operation 2112) a subset of the second memory portion 304B, e.g., for use in memory access and management by the memory controller 202. After the subset of the second memory portion 304B is released, the memory device 240 increases (operation 2114) the current size of the second memory portion 304B allocated to the data processor 312 by at least partially recovering the subset of the second memory portion 304B, which has been released.

Some implementations of this application are directed to dynamic volatile memory usage for in-memory data processing in a memory device. Various examples of these aspects of the disclosure are described as numbered clauses (1, 2, 3, etc.) for convenience. These are provided as examples, and do not limit the subject technology.
Clause 1. A method for dynamically managing memory resources, comprising: at a memory device having a memory controller, a data processor, a volatile memory, and a non-volatile memory, the volatile memory including a first memory portion allocated to the memory controller and a second memory portion allocated to the data processor: caching, in the second memory portion, a plurality of pages to be used by the data processor; monitoring a paging activity level at the second memory portion, the paging activity level corresponding to at least a paging rate for fetching pages from one or more memory resources distinct from the second memory portion; and in accordance with a determination that the paging activity level satisfies a condition, adjusting a current size of the second memory portion allocated to the data processor.
Clause 2. The method of clause 1, wherein at a booting stage of the memory device, each of the first memory portion and the second memory portion has a respective predefined memory size.
Clause 3. The method of clause 1 or 2, further comprising: releasing a subset of the second memory portion by the data processor; wherein adjusting the current size of the second memory portion further includes, after the subset of the second memory portion is released, increasing the current size of the second memory portion allocated to the data processor by at least partially recovering the subset of the second memory portion.
Clause 4. The method of clause 3, further comprising: allocating the released subset of the second memory portion to implementing input/output (I/O) path buffering of the memory device.
Clause 5. The method of any of clauses 1-4, further comprising, in accordance with the condition: when the paging activity level increases to or above a first paging threshold, increasing the current size of the second memory portion by a first predefined portion.
Clause 6. The method of clause 5, further comprising, in accordance with the condition: when the paging activity level drops to or below a second paging threshold, reducing the current size of the second memory portion by a second predefined portion.
Clause 7. The method of clause 6, wherein the first paging threshold is greater than the second paging threshold.
Clause 8. The method of clause 6 or 7, wherein the first predefined portion is greater than the second predefined portion.
Clause 9. The method of any of clauses 1-8, wherein the paging rate is measured by a number of pages fetched from the one or more memory resources during a predefined duration of time.
Clause 10. The method of any of clauses 1-8, wherein the paging rate is measured by a number of pages victimized from the second memory portion during a predefined duration of time.
Clause 11. The method of any of clauses 1-10, wherein the paging activity level is based on a variation of the paging rate during a predefined duration of time.
Clause 12. The method of any of clauses 1-11, wherein the paging activity level further corresponds to a page access queue including a plurality of data requests to be fulfilled via the second memory portion.
Clause 13. The method of clause 12, wherein the paging activity level is a weighted combination of the paging rate of the second memory portion and a length of the page access queue.
Clause 14. The method of any of clauses 1-13, further comprising: executing, by the data processor, an operating system including a balloon driver; and loaning, by the ballon driver, memory space storing a plurality of cold pages to the memory controller, wherein the current size of the second memory portion is adjusted by reclaiming memory space of one or more cold pages of the plurality of cold pages by the balloon driver of the data processor.
Clause 15. The method of clause 14, further comprising, by the memory controller: storing a set of flash translation layer (FTL) table entries in the memory space of the plurality of cold pages; and moving a subset of FTL table entries stored in the one or more cold pages to the non-volatile memory, before the one or more cold pages are reclaimed by the balloon driver.
Clause 16. The method of clause 15, wherein the plurality of cold pages are used as a temporary transfer buffer associated with a memory access operation implemented in response to a host memory access request.
Clause 17. The method of any of clauses 1-16, wherein the second memory portion stores a local paging structure for accessing a set of first pages stored locally in the second memory portion.
Clause 18. The method of any of clauses 1-17, wherein the first memory portion stores a first paging structure for accessing pages stored in one or more of a host memory buffer (HMB), a host-side dynamic random-access memory (DRAM), a hot plugged memory, and the non-volatile memory.
Clause 19. A memory device, comprising: a plurality of processor cores configured to provide a memory controller and a data processor; a volatile memory; and a non-volatile memory, wherein the memory device stores one or more programs comprising instructions for performing a method in any of clauses 1-18.
Clause 20. A non-transitory computer readable storage medium storing one or more programs, the one or more programs comprising instructions that, when executed by a memory device having a memory controller, a data processor, a volatile memory, and a non-volatile memory, cause the memory device to perform a method in any of clauses 1-18.

### Specific Use Case of Dynamic Volatile Memory Usage in a Memory Device (e.g., SSD)

In some embodiments, a memory device 240 is configured to act as a computational storage device (CSD), when a subset of a plurality of processor cores are allocated to a data processor 312 that implements in-memory data processing. A memory size of the memory device 240 (also called the CSD) is limited, and volatile memory 304 (e.g., DRAM 228A, SRAM 224) is statically partitioned. The volatile memory 304 may be shared between a memory controller 202 that implements host-facing NVMe firmware and a data processor 312 that executes a Linux compute environment. An address space of the volatile memory 304 may be statically allocated to the memory controller 202 and the data processor 312 at a boot time of the memory device 240.

In some embodiments, a FTL table for the memory controller 202 may have a limited size, so do addressable NAND flash memory units on a firmware side. The FTL table is used to manage the interaction between the host device 220 and underlying NAND flash memory chips of the memory device 240. The FTL acts as a translator, handling the complexities of how data is stored and retrieved on the memory device 240 based on the FTL table. In some embodiments, for the data processor 312, the amount of volatile memory 304 allocated for data staging and manipulation is also limited on a corresponding compute side. In some implementations of this application, a subset of volatile memory 304S (FIG. 10) allocated to the data processor 312 may be expanded by sharing memory space provided by the host device 220, e.g., using established NVMe protocol semantics. In some embodiments, caches are applied to exchange data with a host device 220 and the data processor 312, and sizes for both the host facing and data processor facing caches are reduced on the firmware of the memory controller 202. In some situations, the memory controller 202, the data processor 312, or both may not fully utilize their static allocations of volatile memory 304.

Some implementations of this application are directed to dynamically sharing volatile memory 304 between the memory controller 202 and the data processor 312, particularly when a block input/output read cache is implemented and exposed to both the host device 220 and the data processor 312 (e.g., more specifically, to a host operating system of the host device 220 and an embedded operating system of the data processor 312). In some embodiments, the memory device 240 includes a hypervisor 1410 configured to provide visibility into a memory map of the firmware of the memory controller 202 and the embedded operating system 506 of the data processor 312. In some embodiments, the embedded operating system of the data processor 312 implements a paging process to search unmapped pages from a non-volatile memory 306 and exit victim pages to the non-volatile memory 306. In some embodiments, the embedded operating system 506 of the data processor 312 implements a balloon driver 1814. The balloon driver 1814 may release a relatively large memory space allocated to a second memory portion 304B of the volatile memory 304 to the memory controller 202, and pressure the embedded operating system 506 to swap pages out to the non-volatile memory 306 (e.g., NAND flash memory).

In some embodiments, pages are dynamically into a temporarily available pool that can provide a DRAM cache of the contents of frequently read NAND blocks. The DRAM cache is always coherent with the underlying NAND media because, at any point in time, the DRAM cache may need to give back the pages to the embedded operating system of the data processor 312, e.g., when the embedded operating system of the data processor 312 needs large quantities of memory space to support a compute function.

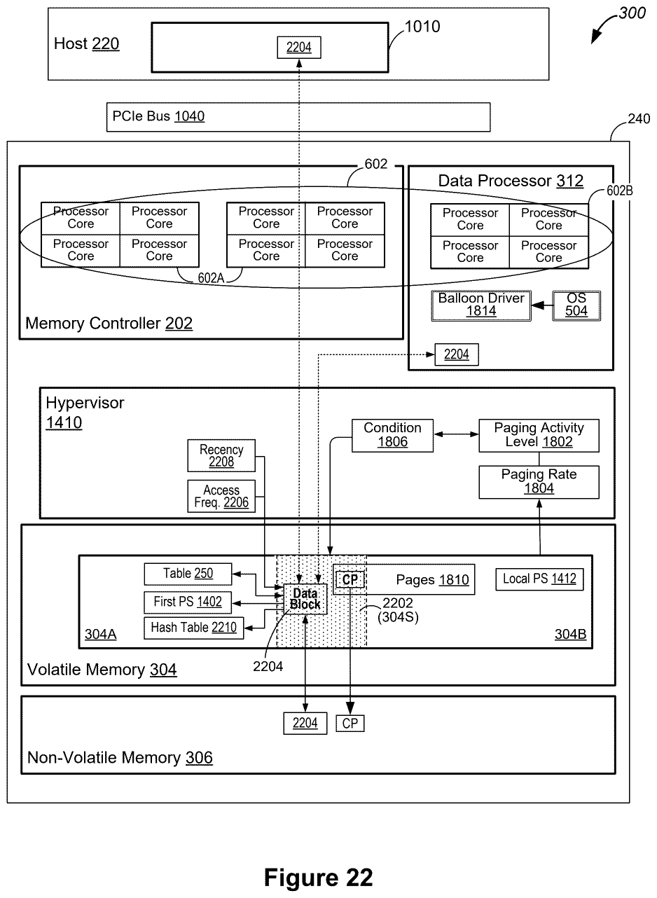

FIG. 22 is a block diagram of an example electronic system 300 that reserves an input/output buffer 2202 for a memory controller 202, in accordance with some embodiments. The memory device 240 includes a memory controller 202, a data processor 312, a volatile memory 304, and a non-volatile memory 306. In some embodiments, an embedded operating system 506 (e.g., Linux OS) is executed by the data processor 312 to perform the in-memory data processing functions. The non-volatile memory 306 (e.g., NAND flash memory cells) is configured to store data independently of whether the electronic system 300 is decoupled from a power source. The volatile memory 304 further includes an SRAM buffer 224, a DRAM buffer 228A, or both, and is configured to store data (e.g., those processed by the data processor 312) temporarily. The volatile memory 304 is partitioned to a first memory portion 304A for storing at least address mapping data 604 temporarily for the memory controller 202 and a second memory portion 304B for storing data temporarily for the data processor 312.

In some embodiments, the memory device 240 stores, in the second memory portion 304B, a plurality of pages 1810 to be used by the data processor 312, and allocates a subset 304S of the second memory portion 304B to act as an input/output (I/O) buffer 2202 for the memory controller 202. A data block 2204 associated with the non-volatile memory 306 is temporarily in the I/O buffer 2202. In some embodiments associated with a write operation, before storing the data block 2204 in the I/O buffer, the memory device 240 (e.g., the memory controller 202) receives the data block 2204 with a logical address from the host device 220 or from the data processor 312, and stores the data block 2204 in the non-volatile memory 306 based on a physical address corresponding to the logical address. Alternatively, in some embodiments associated with a read operation, the I/O buffer 2202 includes a read buffer. Before storing the data block 2204 in the I/O buffer 2202, the memory device 240 (e.g., the memory controller 202) receives a read request including a logical address of the data block from the data processor 312 or from the host device 220, and extracts the data block 2204 from the non-volatile memory 306 based on a physical address corresponding to the logical address. In some embodiments, an address mapping entry (also called an FTL table entry 1816) maps the logical address of the data block 2204 to the physical address in the non-volatile memory 306. The address mapping entry is stored in an L2P address indirection table 250, which may be stored in the volatile memory 304 and optionally copied to the first memory portion 304A that is allocated to the memory controller 202.

Further, in some embodiments, in response to the read request, the memory devices 240 provides the data block 2204 to the data processor 312 or the host device 220 coupled to the memory device 240. In some embodiments, the memory device 240 determines one of an access frequency 2206 and a recency 2208 of the data block 2204. The data block 2204 is stored in the read buffer (e.g., corresponding to the I/O buffer 2202) based on the one of the access frequency 2206 and the recency 2208 of the data block 2204. Additionally, in some embodiments, the first memory portion 304A includes a host interface buffer for managing data into and out of the memory device 240, and a transfer buffer for managing data is prepared, aligned, and moved between the memory controller 240 and the non-volatile memory 306. The I/O buffer 2202 is created in a memory space released from the second memory portion 304B dynamically, and therefore, is distinct from, and supplemental to, the host interface buffer and the transfer buffer of the first portion 304A.

In some embodiments, the I/O buffer 2202 includes a read buffer. The memory device 240 selects the data block 2204 from data stored in the non-volatile memory based on an access frequency 2206 or a recency 2208 of the data block 2204 prior to storing the data block 2204 in the read buffer, and extracts the data block 2204 from the non-volatile memory 306. Stated another way, in some embodiments, the data block 2204 may be frequently or recently accessed, and have an elevated probability of being accessed again. The data block 2204 is stored in the I/O buffer 2202, allowing the data processor 312 and the host device 220 to obtain the data block 2204 from the I/O buffer 2202 with a lower latency for an upcoming data request for the data block 2204.

In some embodiments, the first memory portion 304A stores a hash table 2210. After stores the data block 2204 in the I/O buffer 2202, the memory device 240 updates the hash table 2210 to hash a logical address of the data block 2204 to an indexed location in the I/O buffer 2202. Alternatively, in some embodiments, the first memory portion 304A stores a paging structure 1402. After storing the data block 2204 in the I/O buffer 2202, the memory device 240 updates the paging structure 1402 to map a logical address of the data block 2204 to a physical address of the I/O buffer 2202. In some embodiments, the first paging structure 1402 includes a first page directory 1516 and a plurality of page tables 1518.

In some embodiments associated with a read operation, the I/O buffer 2202 includes a read buffer. After storing the data block 2204 in the I/O buffer 2202, the memory device 240 receives a read request including a logical address of the data block 2204 from one of the data processor 312 or a host 220 coupled to the memory device 240. The memory device 240 extracts the data block 2204 from the read buffer 2202 based on the logical address, and provides the data block 2204 to the data processor 312 or the host 220, without fetching the data block 2204 from the non-volatile memory 306. By these means, a memory access latency is reduced, and associated memory access efficiency is enhanced for the memory device 240.

In some embodiments, the data processor 312 includes a balloon driver 1814. The balloon driver 1814 of the data processor 312 allocates the subset 304S of the second memory portion 304B (e.g., corresponding to the I/O buffer 2202) to a hypervisor 1410, which further allocates the subset 304S of the second memory portion 304B as the I/O buffer 2202.

In some embodiments, the hypervisor 1410 monitors a paging activity level 1802 at the second memory portion 304B, and determines whether to adjust allocation of the subset 304S of the second memory portion 304B based on the paging activity level 1802. In some embodiments, the hypervisor 1410 monitors the paging activity level 1802 at the second memory portion 304B based on updates of a local paging structure 1412 stored in the second memory portion 304B for the data processor 312. In some embodiments, the paging activity level 1802 is measured by a number of pages fetched from one or more memory resources (e.g., non-volatile memory 306) or a number of pages victimized from the second memory portion 304B during a predefined duration of time. In some embodiments, in accordance with a determination that the paging activity level 1802 is greater than a paging threshold, the memory device 240 reduces a size of the second memory portion 304B allocated to act as the I/O buffer. Alternatively, in some embodiments, in accordance with a determination that the paging activity level is lower than a paging threshold, the memory device 240 continues allocation of at least a subset 304S of the second memory portion 304B as the I/O buffer 2202.

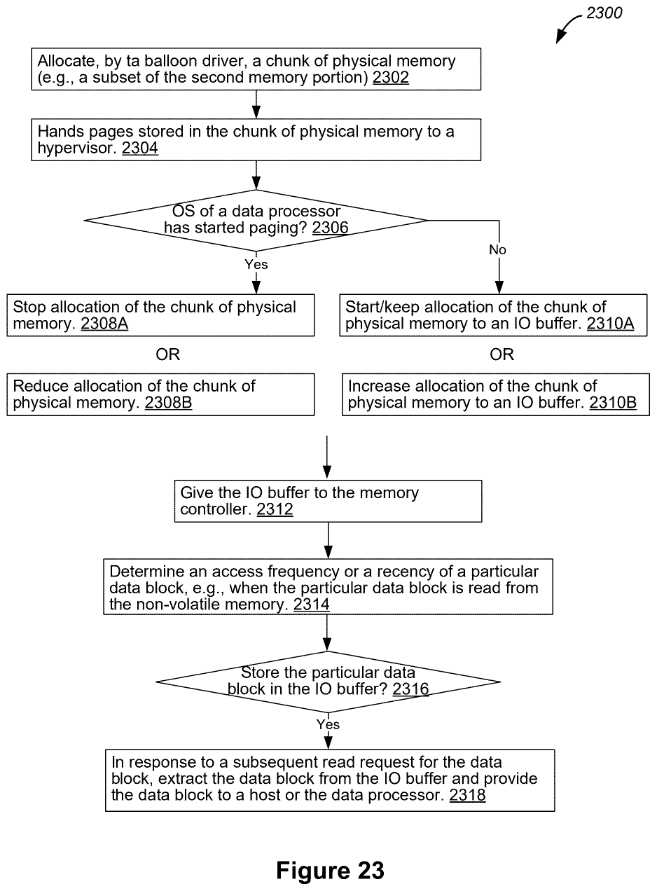

FIG. 23 is a flow diagram of an example method 2300 for dynamically managing volatile memory 304 of a memory device 240 to provide an I/O buffer 2202, in accordance with some embodiments. The memory device 240 is transformed to a computational storage device (CSD) by providing both a memory controller 202 and a data processor 312 using its processing cores. The I/O buffer 2202 be used as a read cache for extracting a data block 2204 including one or more pages stored in the non-volatile memory 306. The data processor 312 executes an embedded operating system 506 including a balloon driver 1814, and the balloon driver 1814 allocates (operation 2302) a chunk of physical memory (e.g., a subset 304S of the second memory portion 304B) and hands (operation 2304) pages stored in the chunk of physical memory to the hypervisor 1410. The hypervisor determines (operation 2306) whether the embedded operating system 506 of the data process 312 has started paging (e.g., moving at least one victim page to the non-volatile memory 306). In accordance with determination that the data processor 312 has started paging (e.g., the paging activity level 1802 is greater than a threshold), the hypervisor 1814 instructs (operation 2308A) the balloon driver 1814 to stop allocation of the chunk of physical memory (e.g., the subset 304S of the second memory portion 304B). In accordance with determination that the data processor has not started paging (e.g., the paging activity level 1802 is lower than a threshold), the hypervisor 1814 instructs (operation 2310A) the balloon driver 1814 to keep allocation of the chunk of physical memory (e.g., the subset 304S of the second memory portion 304B). In some embodiments, the allocated I/O buffer 2202 has a fixed size.

Alternatively, in some embodiments, in accordance with determination that the data processor 312 has started paging (e.g., the paging activity level 1802 is greater than a threshold), the hypervisor 1814 instructs the balloon driver 1814 to reduce (operation 2308B) allocation of the chunk of physical memory (e.g., the subset 304S of the second memory portion 304B), e.g., by a predefined portion (e.g., 5%) for each sampling. In accordance with determination that the data processor 312 has not started paging (e.g., the paging activity level 1802 is lower than a threshold), the hypervisor 1814 instructs the ballon drive to increase (operation 2310B) allocation of the chunk of physical memory (e.g., the subset 304S of the second memory portion 304B), e.g., by a predefined portion (e.g., 5%) for each sampling. By these means, a size of the I/O buffer 2202 is dynamically adjusted based on the page activity level.

In some embodiments, the paging activity level 1802 corresponds to a plurality of activity level ranges, and the I/O buffer 2202 corresponds a plurality of size levels. The greater the paging activity level 1802 of the second memory portion 304B, the smaller the I/O buffer 2202. For example, the paging activity level 1802 increases to the highest one of the plurality of activity level ranges, and the I/O buffer 2202 has the smallest size among the plurality of size levels. Conversely, in another example, the paging activity level 1802 drops into the lowest one of the plurality of activity level ranges, and the I/O buffer 2202 has the greatest size among the plurality of size levels.

In some embodiments, when the operating system 506 has started paging, the set of pages that can be shared and act as the IO buffer 2202 is determined. The corresponding subset 304S of the second memory portion 304B is given (operation 2312) to the firmware of the memory controller 202 (e.g., by way of the hypervisor 1410) for hosting a read cache. Further, in some embodiments, each time a particular data block is read from the non-volatile memory 306, an access frequency 2206 or a recency 2208 of the particular data block is determined (operation 2314). The memory device 240 determines (operation 2316) whether to store the particular data block in the IO buffer 2202 based on the determined access frequency 2206 or the recency 2208. For example, the particular data block includes the data block 2204 and is stored in the IO buffer 2202. In response to a subsequent read request for the data block 2204, the data block 2204 is extracted (operation 2318) from the IO buffer 2202 and provided to a host 220 or the data processor 312 that requests the data block 2204. In some embodiments, writes to that a location of the data block 2204 invalidate the location, and free the location into a pool to be used to cache data for another read.

In some embodiments, while the subset 304S of the second memory portion 304B is allocated to act as an IO buffer 2202, the hypervisor 1410 continuously monitors a paging rate 1804 associated with the embedded operating system 506. In accordance with a determination that the paging rate 1804 starts to increase, the hypervisor 1410 takes back pages allocated to the IO buffer 2202, and returns the pages to embedded operating system 506 of the data processor. The balloon driver 1814 works cooperatively with the hypervisor 1410 to reclaim locations of the memory pages taken back by the hypervisor 1410 to facilitate data processing by the data processor 312. As such, memory space of the second memory portion 304B is dynamically shared with a firmware-managed IO buffer 2204 (e.g., a read buffer), with no or little impact on performance of the embedded operating system 506 and associated applications 508 executed by the data processor 312 of the memory device 240.

In various embodiments of this application, the firmware of the memory controller 202 and the embedded operating system 506 (e.g., Linux OS) of the data processor 312 exist in a cache coherent shared memory architecture. Both sides have full visibility into the shared address space. In some embodiments, the embedded operating system 506 does not access the first memory portion 304A allocated to the memory controller 202 directly. A hypervisor 1410 is present in the memory device 240, and has access to address maps (e.g., paging structures 1402 and 1412) of the both the firmware of the memory controller 202 and the embedded operating system 506 of the data processor 312. A traffic condition (e.g., a paging activity level 1802) of the embedded operating system 506 of the data processor 312 may be used to assess volatile memory usage pressure. The hypervisor 1410 monitors the paging activity level 1802 through updates to page tables of the MMU 514 of the data processor 312. These characteristics of the memory system 300 enables improvement of its overall performance, e.g., by efficiently using volatile memory space, dedicating volatile memory space to higher and better use consistently.

Some implementations of this application are directed to detecting memory pressure in an embedded operating system 506 using a paging and a hypervisor 1410 with MMU page table mapping visibility. Some implementations of this application are directed to a balloon driver technique for carving off temporarily unused pages from an embedded operating system 506 of a data processor 312 for temporary alternative uses. Some implementations of this application are directed to using temporarily available pages for improving block input/output performance by caching frequently read media blocks (e.g., data block 1804 in FIG. 22).

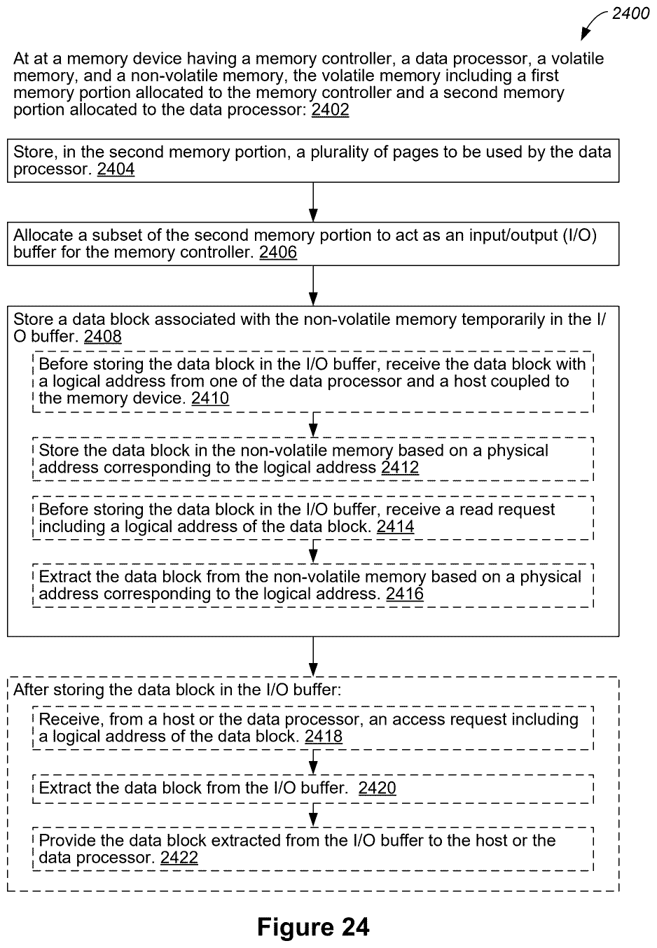

FIG. 24 is a flow diagram of an example method 2400 for managing volatile memory space in a memory device 240, in accordance with some embodiments. The method 2400 is implemented (operation 2402) by a memory device 240 having a memory controller 202, a data processor 312, a volatile memory 304, and a non-volatile memory 306. In some embodiments, the memory device 240 includes a plurality of processor cores 602 configured to provide the memory controller 202 and the data processor 312. For example, the memory device 240 allocates a first subset of processor cores 602A (FIG. 22) to perform a plurality of memory access and management functions of the memory controller 202, and allocates a second subset of processor cores 602B (FIG. 22) to perform a plurality of in-memory data processing functions of the data processor 312. In some embodiments, the volatile memory 304 is partitioned to the first memory portion 304A for storing address mapping data (e.g., an L2P address indirection table 250 in FIG. 2) temporarily for the memory controller 202 and a second memory portion 304B for storing data (e.g., pages 512) temporarily for the data processor 312.

In some embodiments, the second memory portion 304B stores (operation 2404) a plurality of pages to be used by the data processor 312. A subset 304S of the second memory portion 304B is allocated (operation 2406) to act as an input/output (I/O) buffer 2202 for the memory controller 202. The memory device 240 stores (operation 2408) a data block 2204 associated with the non-volatile memory 306 temporarily in the I/O buffer 2202. In some embodiments, before storing the data block 2204 in the I/O buffer 2202, the memory controller 202 receives (operation 2410) the data block 2204 with a logical address from one of the data processor 312 and a host 220 coupled to the memory device 240, and stores (operation 2412) the data block 2204 in the non-volatile memory 306 based on a physical address corresponding to the logical address. In some embodiments, the I/O buffer 2202 includes a read buffer. Before storing the data block 2204 in the I/O buffer 2202, the memory controller 202 receives (operation 2414) a read request including a logical address of the data block 2204, and extracts (operation 2416) the data block 2204 from the non-volatile memory 306 based on a physical address corresponding to the logical address for storage in the IO buffer 2202.

In some embodiments, after storing the data block 2204 in the I/O buffer 2202, the memory controller 202 receives (operation 2418), from a host 220 or the data processor 312, an access request including a logical address of the data block 2204, extracts (operation 2420) the data block 2204 from the I/O buffer 2202, and provides (operation 2422) the data block 2204 extracted from the I/O buffer 2202 to the host 220 or the data processor 312.

Some implementations of this application are directed to dynamic volatile memory usage for in-memory data processing in a memory system. Further examples of these aspects of the disclosure are described as numbered clauses (1, 2, 3, etc.) for convenience. These are provided as examples, and do not limit the subject technology.
Clause 1. A method for dynamically managing memory resources, comprising: at a memory device having a memory controller, a data processor, a volatile memory, and a non-volatile memory, the volatile memory including a first memory portion and a second memory portion distinct from the first memory portion: storing, in the second memory portion, a plurality of pages to be used by the data processor; allocating a subset of the second memory portion to act as an input/output (I/O) buffer for the memory controller; and storing a data block associated with the non-volatile memory temporarily in the I/O buffer.
Clause 2. The method of any clauses 1-, further comprising: before storing the data block in the I/O buffer, receiving the data block with a logical address from one of the data processor and a host coupled to the memory device; and storing the data block in the non-volatile memory based on a physical address corresponding to the logical address.
Clause 3. The method of clause 1 or 2, wherein the I/O buffer includes a read buffer, the method further comprising, before storing the data block in the I/O buffer: receiving a read request including a logical address of the data block; and extracting the data block from the non-volatile memory based on a physical address corresponding to the logical address.
Clause 4. The method of clause 3, further comprising: determining one of an access frequency and a recency of the data block, wherein the data block is stored in the read buffer based on the one of the access frequency and the recency of the data block.
Clause 5. The method of clause 3 or 4, further comprising in response to the read request, providing the data block to the host coupled to the memory device or the data processor.
Clause 6. The method of any of clauses 1-5, further comprising, after storing the data block in the I/O buffer: receiving, from a host or the data processor, an access request including a logical address of the data block; extracting the data block from the I/O buffer; and providing the data block extracted from the I/O buffer to the host or the data processor.
Clause 7. The method of any of clauses 1-6, wherein the I/O buffer includes a read buffer, the method further comprising: selecting the data block from data stored in the non-volatile memory based on an access frequency or a recency of the data block; and prior to storing the data block in the read buffer, extracting the data block from the non-volatile memory.
Clause 8. The method of any clauses 1-7, wherein the first memory portion stores a hash table, the method further comprising: after storing the data block in the I/O buffer, updating the hash table to hash a logical address of the data block to an indexed location in the I/O buffer.
Clause 9. The method of any clauses 1-8, wherein the first memory portion stores a paging structure, the method further comprising: after storing the data block in the I/O buffer, updating the paging structure to map a logical address of the data block to a physical address of the I/O buffer.
Clause 10. The method of any clauses 1-9, wherein the I/O buffer includes a read buffer, the method further comprising, after storing the data block in the I/O buffer: receiving a read request including a logical address of the data block from one of a host coupled to the memory device and the data processor; extracting the data block from the read buffer based on the logical address; and providing the data block to the one of the host coupled to the memory device and the data processor.
Clause 11. The method of any clauses 1-10, wherein the data processor includes a balloon driver, the method further comprising: allocating the subset of the second memory portion by the balloon driver of the data processor to a hypervisor, the subset of the second memory portion being further allocated as the I/O buffer by the hypervisor.
Clause 12. The method of any clauses 1-11, further comprising: monitoring, by a hypervisor, a paging activity level at the second memory portion; and determining whether to adjust allocation of the subset of the second memory portion based on the paging activity level.
Clause 13. The method of clause 12, wherein the hypervisor monitors the paging activity level at the second memory portion based on updates of a local paging structure stored in the second memory portion for the data processor.
Clause 14. The method of clause 12 or 13, wherein the paging activity level is measured by a number of pages fetched from one or more memory resources or a number of pages victimized from the second memory portion during a predefined duration of time.
Clause 15. The method of any of clauses 12-14, further comprising: in accordance with a determination that the paging activity level is greater than a paging threshold, reducing a size of the second memory portion allocated to act as the I/O buffer.
Clause 16. The method of any of clauses 12-15, further comprising: in accordance with a determination that the paging activity level is lower than a paging threshold, continuing allocation of at least a subset of the second memory portion as the I/O buffer.
Clause 17. A memory device, comprising: a plurality of processor cores configured to provide a memory controller and a data processor; a volatile memory; and a non-volatile memory; wherein the memory device stores one or more programs comprising instructions for performing a method of any of clauses 1-16.
Clause 18. A non-transitory computer readable storage medium storing one or more programs, the one or more programs comprising instructions that, when executed by a memory device having a memory controller, a data processor, a volatile memory, and a non-volatile memory, cause the memory device to perform a method of any of clauses 1-16.

Memory is also used to store instructions and data associated with any of the methods 1300, 1700, 2100, 2300, and 2400 and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing any of the methods 1300, 1700, 2100, 2300, and 2400.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

What is claimed is:

1. A method for managing memory resources, comprising:
at a memory device having a plurality of processor cores, a volatile memory, and a non-volatile memory, wherein the plurality of processor cores are configured to provide a memory controller and a data processor:
allocating a subset of volatile memory to the data processor;
determining that a target page is not stored in the subset of volatile memory;
obtaining the target page from a host memory buffer (HMB); and
storing the target page in the subset of volatile memory allocated to the data processor, wherein the data processor is configured to implement a computer operation based on the target page.

2. The method of claim 1, wherein obtaining the target page from the HMB further comprises:
sending a data request for the target page from the data processor to the memory controller; and
at the memory controller, in response to the data request:
fetching the target page from the HMB; and
providing the target page to the data processor.

3. The method of claim 1, wherein obtaining the target page from the HMB further comprises, in accordance with a Non-Volatile Memory express (NVMe) storage access and transport protocol:
sending a first request to a host coupled to the memory device via a Peripheral Component Interconnect Express (PCIe) bus; and
receiving the target page from the host via the PCIe bus.

4. The method of claim 1, further comprising:
in accordance with a NVMe storage access and transport protocol, implementing an isolated dynamic random-access memory (DRAM) backend namespace by the memory controller to manage paging for the data processor.

5. The method of claim 4, further comprising:
executing an embedded operating system by the data processor, including issuing a memory access request for the target page; and
translating the memory access request to the DRAM backend namespace to generate a translated request for the target page.

6. The method of claim 5, wherein the translated request includes a host memory access command that complies with a Transaction Level Protocol (TLP), the method further comprising:
communicating the host memory access command via a PCIe bus coupled between the memory device and a host device.

7. The method of claim 1, wherein the subset of volatile memory further stores a local paging structure, and the method further comprises:
after storing the target page, creating a target mapping entry in the local paging structure, the target mapping entry mapping a target logical address of the target page to a target physical address of the target page in the subset of volatile memory.

8. The method of claim 1, further comprising, prior to storing the target page:
caching, in the subset of volatile memory, a plurality of pages to be used by the data processor.

9. The method of claim 8, further comprising, prior to storing the target page:
identifying a victim page in the plurality of pages stored in the subset of volatile memory, wherein the target page is stored in place of the victim page.

10. The method of claim 9, further comprising storing, in the HMB, the victim page that is stored in the subset of volatile memory.

11. The method of claim 9, wherein the subset of volatile memory further stores a local paging structure including a victim mapping entry mapping a victim logical address of the victim page to a victim physical address of the victim page in the subset of volatile memory, the method further comprising:
unmapping, in the local paging structure, the victim logical address of the victim page to the victim physical address of the victim page in the subset of volatile memory.

12. The method of claim 8, wherein the subset of volatile memory further stores a local paging structure including a plurality of page entries that map logical addresses of the plurality of pages to physical addresses of the plurality of pages in the subset of volatile memory, and the method further comprises:
determining that the target page is unmapped in the local paging structure to determine that the target page is not stored in the subset of volatile memory.

13. The method of claim 1, further comprising, when the target page is not stored in the subset of volatile memory:
causing a page fault;
routing a data request for the target page through a kernel paging subsystem; and
identifying the target page in an HMB page pool, wherein the target page is obtained from the HMB via the memory controller.

14. The method of claim 1, further comprising, by the data processor:
executing an application in a memory operating system, including accessing the target page in the subset of volatile memory and implementing the computer operation on the target page.

15. The method of claim 14, wherein the target page has a target logical address in an application address space associated with the application, and the target logical address is mapped to a target physical address in the subset of volatile memory.

16. The method of claim 1, further comprising, by the data processor:
accessing the target page stored in the subset of volatile memory by the data processor to run a memory operating system.

17. A memory device, comprising:
a memory controller;
a data processor;
a volatile memory; and
a non-volatile memory;
wherein the memory device stores one or more programs comprising instructions for:
allocating a subset of volatile memory to the data processor;
determining that a target page is not stored in the subset of volatile memory;
obtaining the target page from a host memory buffer (HMB); and
storing the target page in the subset of volatile memory allocated to the data processor, wherein the data processor is configured to implement a computer operation based on the target page.

18. The memory device of claim 17, wherein obtaining the target page from the HMB further comprises:
sending a data request for the target page from the data processor to the memory controller; and
at the memory controller, in response to the data request:
fetching the target page from the HMB; and
providing the target page to the data processor.

19. A non-transitory computer readable storage medium storing one or more programs, the one or more programs comprising instructions that, when executed by a memory device having a memory controller, a data processor, a volatile memory, and a non-volatile memory, cause the memory device to perform:
allocating a subset of volatile memory to the data processor;
determining that a target page is not stored in the subset of volatile memory;
obtaining the target page from a host memory buffer (HMB); and
storing the target page in the subset of volatile memory allocated to the data processor, wherein the data processor is configured to implement a computer operation based on the target page.

20. The non-transitory computer readable storage medium of claim 19, wherein obtaining the target page from the HMB further comprises, in accordance with a Non-Volatile Memory express (NVMe) storage access and transport protocol:
sending a first request to a host coupled to the memory device via a Peripheral Component Interconnect Express (PCIe) bus; and
receiving the target page from the host via the PCIe bus.
